(19) United States
(12) Patent Application Publication
(10) Pub. No.: US 2026/0164417 A1
(43) Pub. Date: Jun. 11, 2026

(54) SUBBAND SYNCHRONIZATION WITH LIGHT ADAPTATION BETWEEN SUBBANDS OF AN ACTIVE BANDWIDTH PART

(71) Applicant: QUALCOMM Incorporated, San Diego, CA (US)

(72) Inventors: Diana MAAMARI, San Diego, CA (US); Gabi SARKIS, San Diego, CA (US); Mostafa KHOSHNEVISAN, San Diego, CA (US); Yu ZHANG, San Diego, CA (US); Hyojin LEE, San Diego, CA (US); Morteza SOLTANI, San Diego, CA (US); Weimin DUAN, San Diego, CA (US)

(21) Appl. No.: 18/977,786

(22) Filed: Dec. 11, 2024

(51) Int. Cl. H04W 72/0453; H04W 72/23

(52) U.S. Cl. CPC H04W 72/0453; H04W 72/23

(57) ABSTRACT

Methods, systems, and devices for wireless communication are described. Various aspects generally relate to subband synchronization with light adaptation between subbands of an active bandwidth part (BWP). Some aspects more specifically relate to one or more mechanisms according to which a user equipment (UE) and a network entity reconcile a misalignment regarding at which subband the UE operates in scenarios in which the UE supports multiple subbands within the active BWP. In some examples, the UE may receive first configuration information indicative of a set of parameters associated with the active BWP and, as part of the first configuration information, second configuration information indicative of the multiple subbands within the active BWP. Each of the multiple subbands may include a different valid quantity of physical resource blocks (PRBs) and, in some implementations, the UE may monitor for subband misalignments in accordance with the different valid quantities of PRBs.

### FIELD OF TECHNOLOGY

The following relates to wireless communication, including subband synchronization with light adaptation between subbands of an active bandwidth part (BWP).

### BACKGROUND

Wireless communications systems are widely deployed to provide various types of communication content such as voice, video, packet data, messaging, broadcast, and so on. These systems may be capable of supporting communication with multiple users by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communication systems, a UE may support multiple bandwidth parts (BWPs) and may communicate with a network entity via an active BWP of the multiple BWPs. Each BWP of the multiple BWPs may be associated with a respective set of configured parameters such that, in some cases, the UE may use a first set of configured parameters in accordance with communicating via a first BWP and may use a second set of configured parameters in accordance with communicating via a second BWP. Switching between BWPs may be associated with a corresponding switch between sets of configured parameters, which may involve a relatively “heavy” reconfiguration at the UE.

### SUMMARY

The systems, methods, and devices of this disclosure each have several innovative aspects, no single one of which is solely responsible for the desirable attributes disclosed herein.

One innovative aspect of the subject matter described in this disclosure can be implemented in an apparatus for wireless communication at a user equipment (UE). The apparatus may include a processing system that includes processor circuitry and memory circuitry that stores code. The processing system may be configured to cause the apparatus to receive first configuration information indicative of a set of parameters associated with an active bandwidth part (BWP) of the UE and, as part of the first configuration information, second configuration information indictive of at least a first subband that includes a first valid quantity of physical resource blocks (PRBs) and a second subband that includes a second valid quantity of PRBs, receive a first downlink control information (DCI) message that indicates a frequency domain resource allocation (FDRA) associated with a downlink data message, the FDRA including one or more PRBs that are invalid for the first subband and valid for the second subband, and transmit an uplink message in accordance with the FDRA including the one or more PRBs.

Another innovative aspect of the subject matter described in this disclosure can be implemented in a method for wireless communication by or at a UE. The method may include receiving first configuration information indicative of a set of parameters associated with an active BWP of the UE and, as part of the first configuration information, second configuration information indictive of at least a first subband that includes a first valid quantity of PRBs and a second subband that includes a second valid quantity of PRBs, receiving a first DCI message that indicates an FDRA associated with a downlink data message, the FDRA including one or more PRBs that are invalid for the first subband and valid for the second subband, and transmitting an uplink message in accordance with the FDRA including the one or more PRBs.

Another innovative aspect of the subject matter described in this disclosure can be implemented in an apparatus for wireless communication at a UE. The apparatus may include means for receiving first configuration information indicative of a set of parameters associated with an active BWP of the UE and, as part of the first configuration information, second configuration information indictive of at least a first subband that includes a first valid quantity of PRBs and a second subband that includes a second valid quantity of PRBs, means for receiving a first DCI message that indicates an FDRA associated with a downlink data message, the FDRA including one or more PRBs that are invalid for the first subband and valid for the second subband, and means for transmitting an uplink message in accordance with the FDRA including the one or more PRBs.

Another innovative aspect of the subject matter described in this disclosure can be implemented in a non-transitory computer-readable medium storing code for wireless communication by or at a UE. The code may include instructions executable by a processing system to receive first configuration information indicative of a set of parameters associated with an active BWP of the UE and, as part of the first configuration information, second configuration information indictive of at least a first subband that includes a first valid quantity of PRBs and a second subband that includes a second valid quantity of PRBs, receive a first DCI message that indicates an FDRA associated with a downlink data message, the FDRA including one or more PRBs that are invalid for the first subband and valid for the second subband, and transmit an uplink message in accordance with the FDRA including the one or more PRBs.

In some examples of the method, UEs, apparatuses, and non-transitory computer-readable medium described herein, the UE operates at the first subband at a reception time of the first DCI message and the FDRA may be not limited to a set of usable PRBs that the UE or the apparatus considers to be valid for data reception within the first subband in accordance with the FDRA including the one or more PRBs that may be invalid for the first subband and valid for the second subband.

In some examples of the method, UEs, apparatuses, and non-transitory computer-readable medium described herein, the uplink message includes a negative acknowledgment (NACK) and the UE switches to the second subband in accordance with the FDRA including the one or more PRBs that may be valid for the second subband.

In some examples of the method, UEs, apparatuses, and non-transitory computer-readable medium described herein, the uplink message includes an indication that the FDRA may be not limited to the set of usable PRBs that the UE or the apparatus considers to be valid for the data reception within the first subband and the UE switches to the second subband in accordance with the FDRA including the one or more PRBs that may be valid for the second subband.

In some examples of the method, UEs, apparatuses, and non-transitory computer-readable medium described herein, the uplink message includes an uplink control information (UCI) message or a medium access control (MAC) control element (MAC-CE) and a field associated with indicating mismatched subband scenarios within the UCI message or the MAC-CE includes the indication that the FDRA may be not limited to the set of usable PRBs that the UE or the apparatus considers to be valid for the data reception within the first subband.

In some examples of the method, UEs, apparatuses, and non-transitory computer-readable medium described herein, the uplink message includes a feedback message and a multi-bit field within the feedback message includes the indication that the FDRA may be not limited to the set of usable PRBs that the UE or the apparatus considers to be valid for the data reception within the first subband.

In some examples of the method, UEs, apparatuses, and non-transitory computer-readable medium described herein, a first value of the multi-bit field within the feedback message corresponds to the indication of the FDRA being not limited to the set of usable PRBs that the UE or the apparatus considers to be valid for the data reception within the first subband; a second value of the multi-bit field within the feedback message corresponds to a positive acknowledgment (ACK) associated with the downlink data message; and a third value of the multi-bit field within the feedback message corresponds to a NACK associated with the downlink data message.

In some examples of the method, UEs, apparatuses, and non-transitory computer-readable medium described herein, the one or more PRBs of the FDRA may be valid for the second subband in accordance with the first DCI message including an indication of the second subband or the FDRA failing to satisfy a scheduling restriction associated with the first subband.

Another innovative aspect of the subject matter described in this disclosure can be implemented in an apparatus for wireless communication at a network entity. The apparatus may include a processing system that includes processor circuitry and memory circuitry that stores code. The processing system may be configured to cause the apparatus to output first configuration information indicative of a set of parameters associated with an active BWP of a UE and, as part of the first configuration information, second configuration information indictive of at least a first subband that includes a first valid quantity of PRBs and a second subband that includes a second valid quantity of PRBs, output a first DCI message that indicates an FDRA associated with a downlink data message, the FDRA including one or more PRBs that are invalid for the first subband and valid for the second subband, and obtain an uplink message in accordance with the FDRA including the one or more PRBs.

Another innovative aspect of the subject matter described in this disclosure can be implemented in a method for wireless communication by or at a network entity. The method may include outputting first configuration information indicative of a set of parameters associated with an active BWP of a UE and, as part of the first configuration information, second configuration information indictive of at least a first subband that includes a first valid quantity of PRBs and a second subband that includes a second valid quantity of PRBs, outputting a first DCI message that indicates an FDRA associated with a downlink data message, the FDRA including one or more PRBs that are invalid for the first subband and valid for the second subband, and obtaining an uplink message in accordance with the FDRA including the one or more PRBs.

Another innovative aspect of the subject matter described in this disclosure can be implemented in an apparatus for wireless communication at a network entity. The apparatus may include means for outputting first configuration information indicative of a set of parameters associated with an active BWP of a UE and, as part of the first configuration information, second configuration information indictive of at least a first subband that includes a first valid quantity of PRBs and a second subband that includes a second valid quantity of PRBs, means for outputting a first DCI message that indicates an FDRA associated with a downlink data message, the FDRA including one or more PRBs that are invalid for the first subband and valid for the second subband, and means for obtaining an uplink message in accordance with the FDRA including the one or more PRBs.

Another innovative aspect of the subject matter described in this disclosure can be implemented in a non-transitory computer-readable medium storing code for wireless communication by or at a network entity. The code may include instructions executable by a processing system to output first configuration information indicative of a set of parameters associated with an active BWP of a UE and, as part of the first configuration information, second configuration information indictive of at least a first subband that includes a first valid quantity of PRBs and a second subband that includes a second valid quantity of PRBs, output a first DCI message that indicates an FDRA associated with a downlink data message, the FDRA including one or more PRBs that are invalid for the first subband and valid for the second subband, and obtain an uplink message in accordance with the FDRA including the one or more PRBs.

In some examples of the method, network entities, apparatuses, and non-transitory computer-readable medium described herein, the uplink message includes a NACK in accordance with the FDRA including the one or more PRBs that may be invalid for the first subband and valid for the second subband and the network entity or the apparatus expects the UE to switch to the second subband in accordance with the FDRA including the one or more PRBs that may be valid for the second subband.

In some examples of the method, network entities, apparatuses, and non-transitory computer-readable medium described herein, the uplink message includes an indication that the FDRA may be not limited to a set of usable PRBs that the UE considers to be valid for data reception within the first subband and the network entity or the apparatus expects the UE to switch to the second subband in accordance with the FDRA including the one or more PRBs that may be valid for the second subband.

In some examples of the method, network entities, apparatuses, and non-transitory computer-readable medium described herein, the uplink message includes a UCI message or a MAC-CE and a field associated with indicating mismatched subband scenarios within the UCI message or the MAC-CE includes the indication that the FDRA may be not limited to the set of usable PRBs that the UE considers to be valid for the data reception within the first subband.

In some examples of the method, network entities, apparatuses, and non-transitory computer-readable medium described herein, the uplink message includes a feedback message and a multi-bit field within the feedback message includes the indication that the FDRA may be not limited to the set of usable PRBs that the UE considers to be valid for the data reception within the first subband.

In some examples of the method, network entities, apparatuses, and non-transitory computer-readable medium described herein, a first value of the multi-bit field within the feedback message corresponds to the indication of the FDRA being not limited to the set of usable PRBs that the UE considers to be valid for the data reception within the first subband; a second value of the multi-bit field within the feedback message corresponds to an ACK associated with the downlink data message; and a third value of the multi-bit field within the feedback message corresponds to a NACK associated with the downlink data message.

In some examples of the method, network entities, apparatuses, and non-transitory computer-readable medium described herein, the one or more PRBs of the FDRA may be valid for the second subband in accordance with the first DCI message including an indication of the second subband or the FDRA failing to satisfy a scheduling restriction associated with the first subband.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system including user equipments (UEs) and network entities that supports subband synchronization with light adaptation between subbands of an active bandwidth part (BWP).

FIG. 2 shows an example of a subband configuration, of multiple subbands within an active BWP, that supports subband synchronization with light adaptation between subbands of an active BWP.

FIGS. 3A, 3B, and 4 show examples of communication timelines in which a downlink control information (DCI) message schedules a data message in accordance with light adaptation between subbands of an active BWP.

FIG. 5 shows an example of a signaling diagram between a UE and a network entity, in accordance with a scheduling expectation at the UE associated with a subband at which the UE operates, that supports subband synchronization with light adaptation between subbands of an active BWP.

FIGS. 6 and 7 show examples of communication timelines in which a DCI message schedules a data message in accordance with light adaptation between subbands of an active BWP.

FIG. 8 shows an example of a process flow illustrative of signaling between a UE and a network entity that supports subband synchronization with light adaptation between subbands of an active BWP.

FIGS. 9 and 10 show block diagrams of devices that support subband synchronization with light adaptation between subbands of an active BWP.

FIG. 11 shows a block diagram of a communications manager that supports subband synchronization with light adaptation between subbands of an active BWP.

FIG. 12 shows a diagram of a system including a device that supports subband synchronization with light adaptation between subbands of an active BWP.

FIGS. 13 and 14 show block diagrams of devices that support subband synchronization with light adaptation between subbands of an active BWP.

FIG. 15 shows a block diagram of a communications manager that supports subband synchronization with light adaptation between subbands of an active BWP.

FIG. 16 shows a diagram of a system including a device that supports subband synchronization with light adaptation between subbands of an active BWP.

FIGS. 17-20 show flowcharts illustrating methods that support subband synchronization with light adaptation between subbands of an active BWP.

### DETAILED DESCRIPTION

In some wireless communication systems, a user equipment (UE) may support multiple bandwidth parts (BWPs) and may communicate with a network entity via an active BWP of the multiple BWPs. Each of the multiple BWPs that a UE supports may be associated with a respective set of configured parameters such that, in some cases, the UE may use a first set of configured parameters in accordance with communicating via a first BWP and may use a second set of configured parameters in accordance with communicating via a second BWP. For example, some parameters may be configured on a per-BWP basis. Switching between BWPs may be associated with a corresponding switch between sets of configured parameters, which may involve a relatively “heavy” reconfiguration at the UE. Such a “heavy” reconfiguration may be associated with a relatively high cost at the UE to store the respective sets of configured parameters for each BWP or a relatively high timeline/reprogramming cost at the UE to reconfigure parameters each time a BWP switch occurs.

To mitigate such reconfiguration costs associated with BWP switches, some systems may support a light bandwidth adaptation mechanism according to which a network entity may configure multiple subbands within a BWP, with the multiple subbands inheriting some of the parameters configured for the BWP and with each of the multiple subbands being configured with relatively smaller sets of subband-specific parameters. In accordance with each of the multiple subbands being configured with relatively smaller sets of subband-specific parameters and otherwise being associated with the same parameters as the larger BWP, switching between subbands may involve a relatively “light” adaptation at a UE. Such a “light” adaptation may be associated with a relatively low cost at the UE to store respective sets of parameters for each subband or a relatively low timeline/reprogramming cost at the UE to reconfigure parameters each time a subband switch occurs. A subband-specific parameter may include bandwidth such that, for example, different subbands may be associated with (may include) different valid quantities of physical resource blocks (PRBs). A valid quantity of PRBs may correspond to a set of PRBs that is (expected to be) usable for communications between a UE and a network entity. If a scheduled data message exceeds a valid quantity of PRBs of a subband at which a UE operates, the scheduled data message may violate a scheduling expectation at the UE. Such a scheduling expectation violation may at least implicitly indicate a mismatch between a UE and a network entity regarding at which subband the UE is to operate. In systems in which downlink control information (DCI) messages are decodable across various subbands within an active BWP, baseline feedback mechanisms may be insufficient to reconcile subband mismatches between a UE and a network entity (as one or both of the two devices may incorrectly assume a data communication failure instead of a scheduling error). Thus, some systems may benefit from additional mechanisms according to which one or both of a UE and a network entity may reconcile subband mismatches.

Various aspects generally relate to subband synchronization with light adaptation between subbands of an active BWP. Some aspects more specifically relate to one or more signaling- or configuration-based mechanisms according to which a UE and a network entity may reconcile a mismatch regarding at which subband the UE operates in scenarios in which the UE supports multiple subbands within an active BWP. In some examples, the UE may receive first configuration information indicative of a set of parameters associated with the active BWP and, as part of or within the first configuration information, second configuration information indicative of the multiple subbands within the active BWP. Each subband of the multiple subbands may be associated with (such as include) a different valid quantity of PRBs and, in some implementations, the UE may parse DCI messages in accordance with the different valid quantities of PRBs. For example, the UE may receive a DCI message that includes scheduling information associated with a data message and that indicates a frequency domain resource allocation (FDRA) associated with the data message and, in some implementations, the UE may parse the DCI message to determine whether the FDRA includes one or more PRBs that are invalid for a subband at which the UE operates.

In examples in which the FDRA includes one or more PRBs that are invalid for a subband at which the UE operates, but that are valid for another subband within the active BWP, the UE may transmit an uplink message to the network entity. The uplink message may include information associated with a detected subband mismatch between the UE and the network entity. Additionally, or alternatively, the uplink message may include an acknowledgment (ACK) or a negative ACK (NACK) associated with the data message (depending on whether the UE is able to decode the scheduled data message). In some examples, the UE may monitor for another DCI message to instruct the UE to switch to a different subband within the active BWP in accordance with transmitting the uplink message to the network entity. In some other examples, the UE may (autonomously) switch to a different subband within the active BWP in accordance with detecting the subband mismatch (and determining at which subband the network entity assumes the UE is operating).

Particular aspects of the subject matter of the present disclosure may be implemented to realize one or more of the following advantages. For example, by parsing DCI messages in accordance with the different valid quantities of PRBs of the multiple subbands within the active BWP, the UE may accurately and reliably detect whether a scheduled data message violates a scheduling expectation at the UE. In accordance with accurately and reliably detecting whether a scheduled data message violates a scheduling expectation at the UE, the UE may inform the network entity of a subband misalignment or switch to a different subband within the active BWP, or both, with low latency, which may tighten coordination and synchronization between the UE and the network entity, which may in turn support greater communication reliability between the UE and the network entity. By supporting greater communication reliability, the UE and the network entity may achieve greater spectral efficiency, higher data rates, and greater system capacity, among other benefits. Further, by achieving tighter coordination and synchronization to reconcile and mitigate scenarios in which subband misalignments occur, more systems may support light adaptation between subbands of an active BWP, which may reduce power consumption, reduce device complexity, and facilitate lower latency bandwidth switches by facilitating an adaptation of select (and relatively few) parameters on a per-subband basis and maintaining other parameters across subbands.

Aspects of the disclosure are initially described in the context of wireless communications systems. Additionally, aspects of the disclosure are illustrated by and described with reference to a subband configuration, communication timelines, a signaling diagram, and a process flow. Aspects of the disclosure are further illustrated by and described with reference to apparatus diagrams, system diagrams, and flowcharts that relate to subband synchronization with light adaptation between subbands of an active BWP.

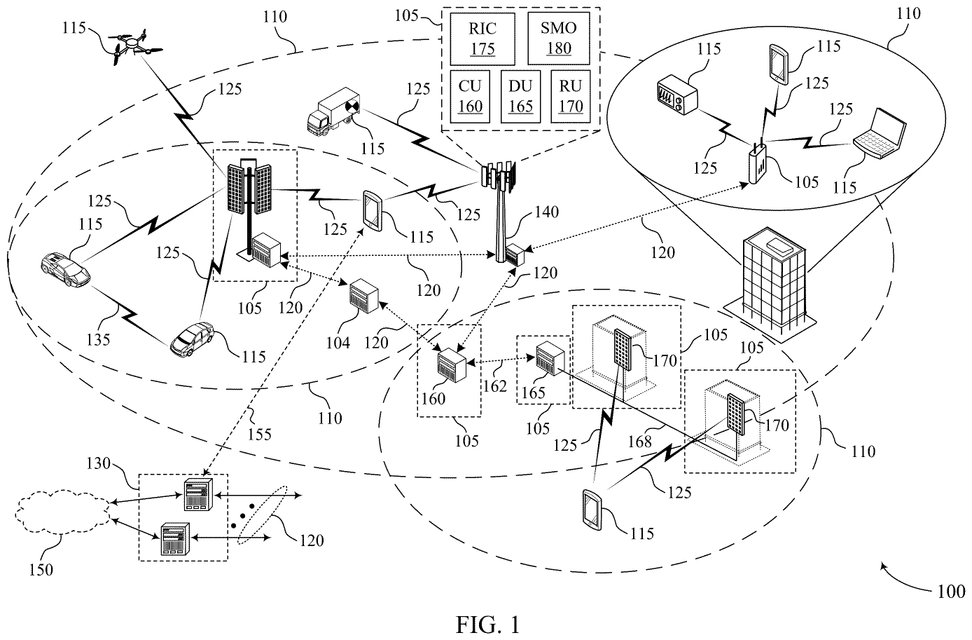

FIG. 1 shows an example of a wireless communications system 100 including UEs 115 and network entities 105 that supports subband synchronization with light adaptation between subbands of an active bandwidth part. The wireless communications system 100 may include one or more devices, such as one or more network devices (such as network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (such as a radio frequency (RF) access link). For example, a network entity 105 may support a coverage area 110 (such as a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (such as other wireless communication devices, including UEs 115 or network entities 105), as shown in FIG. 1.

As described herein, a node of the wireless communications system 100, which may be referred to as a network node, or a wireless node, may be a network entity 105 (such as any network entity described herein), a UE 115 (such as any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (such as in accordance with an S1, N2, N3, or other interface protocol). In some examples, network entities 105 may communicate with one another via backhaul communication link(s) 120 (such as in accordance with an X2, Xn, or other interface protocol) either directly (such as directly between network entities 105) or indirectly (such as via the core network 130). In some examples, network entities 105 may communicate with one another via a midhaul communication link 162 (such as in accordance with a midhaul interface protocol) or a fronthaul communication link 168 (such as in accordance with a fronthaul interface protocol), or any combination thereof. The backhaul communication link(s) 120, midhaul communication links 162, or fronthaul communication links 168 may be or include one or more wired links (such as an electrical link, an optical fiber link) or one or more wireless links (such as a radio link, a wireless optical link), among other examples or various combinations thereof. A UE 115 may communicate with the core network 130 via a communication link 155.

One or more of the network entities 105 or network equipment described herein may include or may be referred to as a base station 140 (such as a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (such as a base station 140) may be implemented in an aggregated (such as monolithic, standalone) base station architecture, which may be configured to utilize a protocol stack that is physically or logically integrated within one network entity (such as a network entity 105 or a single RAN node, such as a base station 140).

In some examples, a network entity 105 may be implemented in a disaggregated architecture (such as a disaggregated base station architecture, a disaggregated RAN architecture), which may be configured to utilize a protocol stack that is physically or logically distributed among multiple network entities (such as network entities 105), such as an integrated access and backhaul (IAB) network, an open RAN (O-RAN) (such as a network configuration sponsored by the O-RAN Alliance), or a virtualized RAN (vRAN) (such as a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (such as a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (such as separate physical locations). In some examples, one or more of the network entities 105 of a disaggregated RAN architecture may be implemented as virtual units (such as a virtual CU (VCU), a virtual DU (VDU), a virtual RU (VRU)).

The split of functionality between a CU 160, a DU 165, and an RU 170 is flexible and may support different functionalities depending on which functions (such as network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (such as layer 3 (L3 ), layer 2 (L2)) functionality and signaling (such as Radio Resource Control (RRC), service data adaptation protocol (SDAP), Packet Data Convergence Protocol (PDCP)). The CU 160 (such as one or more CUs) may be connected to a DU 165 (such as one or more DUs) or an RU 170 (such as one or more RUs), or some combination thereof, and the DUs 165, RUs 170, or both may host lower protocol layers, such as layer 1 (L1 ) (such as physical (PHY) layer) or L2 (such as radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (such as via one or multiple different RUs, such as an RU 170). In some cases, a functional split between a CU 160 and a DU 165 or between a DU 165 and an RU 170 may be within a protocol layer (such as some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (such as F1, F1-c, F1-u), and a DU 165 may be connected to an RU 170 via a fronthaul communication link 168 (such as open fronthaul (FH) interface). In some examples, a midhaul communication link 162 or a fronthaul communication link 168 may be implemented in accordance with an interface (such as a channel) between layers of a protocol stack supported by respective network entities (such as one or more of the network entities 105) that are in communication via such communication links.

In some wireless communications systems (such as the wireless communications system 100), infrastructure and spectral resources for radio access may support wireless backhaul link capabilities to supplement wired backhaul connections, providing an IAB network architecture (such as to a core network 130). In some cases, in an IAB network, one or more of the network entities 105 (such as network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (such as IAB donors) may be in communication with one or more additional devices (such as IAB node(s) 104) via supported access and backhaul links (such as backhaul communication link(s) 120). IAB node(s) 104 may include an IAB mobile termination (IAB-MT) controlled (such as scheduled) by one or more DUs (such as DUs 165) of a coupled IAB donor. An IAB-MT may be equipped with an independent set of antennas for relay of communications with UEs 115 or may share the same antennas (such as of an RU 170) of IAB node(s) 104 used for access via the DU 165 of the IAB node(s) 104 (such as referred to as virtual IAB-MT (vIAB-MT)). In some examples, the IAB node(s) 104 may include one or more DUs (such as DUs 165) that support communication links with additional entities (such as IAB node(s) 104, UEs 115) within the relay chain or configuration of the access network (such as downstream). In such cases, one or more components of the disaggregated RAN architecture (such as the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support subband synchronization with light adaptation between subbands of an active bandwidth part as described herein. For example, some operations described as being performed by a UE 115 or a network entity 105 (such as a base station 140) may additionally, or alternatively, be performed by one or more components of the disaggregated RAN architecture (such as components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (such as one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (such as a bandwidth part (BWP)) that is operated according to one or more PHY layer channels for a given RAT (such as LTE, LTE-A, LTE-A Pro, NR). Each PHY layer channel may carry acquisition signaling (such as synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (such as entity, sub-entity) of a network entity 105. For example, the terms “transmitting,” “receiving,” or “communicating,” when referring to a network entity 105, may refer to any portion of a network entity 105 (such as a base station 140, a CU 160, a DU 165, a RU 170) of a RAN communicating with another device (such as directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (such as an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (such as of the same or a different RAT).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (such as 1.4, 3, 5, 10, 15, 20, 40, or 80 megahertz (MHz)). Devices of the wireless communications system 100 (such as the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (such as a sub-band, a BWP) or all of a carrier bandwidth.

Signal waveforms transmitted via a carrier may be made up of multiple subcarriers (such as using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (such as a duration of one modulation symbol) and one subcarrier, in which case the symbol period and subcarrier spacing may be inversely related. The quantity of bits carried by each resource element may depend on the modulation scheme (such as the order of the modulation scheme, the coding rate of the modulation scheme, or both), such that a relatively higher quantity of resource elements (such as in a transmission duration) and a relatively higher order of a modulation scheme may correspond to a relatively higher rate of communication. A wireless communications resource may refer to a combination of an RF spectrum resource, a time resource, and a spatial resource (such as a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (such as 10 milliseconds (ms)). Each radio frame may be identified by a system frame number (SFN) (such as ranging from 0 to 1023).

Each frame may include multiple consecutively-numbered subframes or slots, and each subframe or slot may have the same duration. In some examples, a frame may be divided (such as in the time domain) into subframes, and each subframe may be further divided into a quantity of slots. Alternatively, each frame may include a variable quantity of slots, and the quantity of slots may depend on subcarrier spacing. Each slot may include a quantity of symbol periods (such as depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (such as N_{f}) sampling periods. The duration of a symbol period may depend on the subcarrier spacing or frequency band of operation.

A subframe, a slot, a mini-slot, or a symbol may be the smallest scheduling unit (such as in the time domain) of the wireless communications system 100 and may be referred to as a transmission time interval (TTI). In some examples, the TTI duration (such as a quantity of symbol periods in a TTI) may be variable. Additionally, or alternatively, the smallest scheduling unit of the wireless communications system 100 may be dynamically selected (such as in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (such as a control resource set (CORESET)) for a physical control channel may be defined by a set of symbol periods and may extend across the system bandwidth or a subset of the system bandwidth of the carrier. One or more control regions (such as CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (such as control channel elements (CCEs)) associated with encoded information for a control information format having a given payload size. Search space sets may include common search space sets configured for sending control information to UEs 115 (such as one or more UEs) or may include UE-specific search space sets for sending control information to a UE 115 (such as a specific UE).

In some examples, a network entity 105 (such as a base station 140, an RU 170) may be movable and therefore provide communication coverage for a moving coverage area, such as the coverage area 110. In some examples, coverage areas 110 (such as different coverage areas) associated with different technologies may overlap, but the coverage areas 110 (such as different coverage areas) may be supported by the same network entity (such as a network entity 105). In some other examples, overlapping coverage areas, such as a coverage area 110, associated with different technologies may be supported by different network entities (such as the network entities 105). The wireless communications system 100 may include, for example, a heterogeneous network in which different types of the network entities 105 support communications for coverage areas 110 (such as different coverage areas) using the same or different RATs.

Some UEs 115 may be configured to employ operating modes that reduce power consumption, such as half-duplex communications (such as a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (such as according to narrowband communications), or a combination of these techniques. For example, some UEs 115 may be configured for operation using a narrowband protocol type that is associated with a defined portion or range (such as set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (such as one or more of the UEs 115) via a device-to-device (D2D) communication link, such as a D2D communication link 135 (such as in accordance with a peer-to-peer (P2P), D2D, or sidelink protocol). In some examples, one or more UEs 115 of a group that are performing D2D communications may be within the coverage area 110 of a network entity 105 (such as a base station 140, an RU 170), which may support aspects of such D2D communications being configured by (such as scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (such as a mobility management entity (MME), an access and mobility management function (AMF)) and at least one user plane entity that routes packets or interconnects to external networks (such as a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (such as base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (such as less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (such as LAA). Operations using unlicensed spectrum may include downlink transmissions, uplink transmissions, P2P transmissions, or D2D transmissions, among other examples.

A network entity 105 (such as a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (such as a network entity 105, a UE 115) to shape or steer an antenna beam (such as a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (such as with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (such as the communication link(s) 125, a D2D communication link 135). HARQ may include a combination of error detection (such as using a cyclic redundancy check (CRC)), forward error correction (FEC), and retransmission (such as automatic repeat request (ARQ)). HARQ may improve throughput at the MAC layer in relatively poor radio conditions (such as low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may support multiple BWPs and may communicate with a network entity 105 via an active BWP of the multiple BWPs. Such multiple BWPs may include up to four uplink BWPs and up to four downlink BWPs, although UEs 115 described herein may support any quantity of uplink or downlink BWPs. For example, a UE may support any quantity of BWPs for communication via one or more uplink channels and may support any quantity of BWPs for communication via one or more downlink channels. Uplink channels may include a physical uplink shared channel (PUSCH), a physical uplink control channel (PUCCH), and a physical random access channel (PRACH). Downlink channels may include a physical downlink shared channel (PDSCH) and a physical downlink control channel (PDCCH). Thus, supporting and switching between different BWPs may enable a UE 115 to experience flexible spectrum assignment different from a carrier bandwidth. A UE 115 may support a single active BWP, such that the UE 115 may use one BWP as an active BWP at a time. Each of the multiple BWPs that a UE 115 supports may be associated with a respective set of configured parameters such that, in some cases, the UE 115 may use a first set of configured parameters in accordance with communicating via a first BWP and may use a second set of configured parameters in accordance with communicating via a second BWP.

For example, parameters associated with one or more of a bandwidth (such as 20 MHz or 100 MHz, among other examples), a subcarrier spacing (SCS), a modulation and coding scheme (MCS) table, a channel state information (CSI) configuration, a maximum rank, a control resource set (CORESET), a sounding reference signal (SRS) configuration, a configured grant (CG) configuration, semi-persistently scheduled communications, beam failure reporting parameters, and radio link management (RLM) parameters may be configured on a per-BWP basis. Such parameters may be examples of RRC parameters, which may be organized in a BWP container (such that, in some aspects, BWPs may be understood as profiles). Use of BWPs may enable adaptation of radio (such as RRC) parameters at a UE 115. A BWP change may occur via RRC or DCI signaling or in accordance with an expiry of a BWP inactive timer. A change in a BWP may be associated with a change in a monitored bandwidth, such as a change from 20 MHz to 100 MHz for a time period within which a relatively large amount of data is to be transmitted to a UE 115.

Switching between BWPs may be associated with a corresponding switch between sets of configured parameters, which may involve a relatively “heavy” reconfiguration at a UE 115. For example, issues may arise in some deployment scenarios because of a relatively large quantity of configurations that are BWP-dependent. Such a “heavy” reconfiguration may be associated with a relatively high cost at the UE 115 to store the respective sets of configured parameters for each BWP or a relatively high timeline/reprogramming cost at the UE 115 to reconfigure parameters each time a BWP switch occurs. Thus, while supporting configurations on a per-BWP basis may provide relatively greater system flexibility, having a relatively large quantity of configurations that are BWP-dependent may incur some costs in terms of complexity at a UE 115.

For example, from a perspective of a UE 115, the UE 115 may either pay a relatively higher area cost to store a complete set of configurations (such as for a complete set of BWPs) or pay a timeline cost to a reprogramming cost each time the UE 115 switches from one BWP to another BWP. A significant portion of a time delay associated with BWP switching may be spent reconfiguring the UE 115 with a set of parameters associated with the BWP to which the UE 115 is switching. Such reconfiguration may include both hardware and firmware reconfiguration. Further, with BWP there may be a risk of a UE 115 being unreachable for a duration at times when the UE 115 moves to a wider BWP while a network entity 105 remains in a narrow BWP, or vice versa. A UE 115 may be unable to receive signaling (such as a DCI message) from a network entity 105 for such durations.

To mitigate such reconfiguration costs associated with BWP switches, some systems may support a light bandwidth adaptation mechanism according to which a network entity 105 may configure multiple subbands within a BWP, with the multiple subbands inheriting some of the parameters configured for the BWP and with each of the multiple subbands being configured with relatively smaller sets of unique parameters. For example, a UE 115 may receive first configuration information indicative of a set of parameters associated with a BWP and, as part of or within the first configuration information, second configuration information indicative of multiple subbands within the BWP. A unique parameter between the multiple subbands may include bandwidth such that, for example, a first subband may be associated with a first valid quantity of PRBs and a second subband may be associated with a second valid quantity of PRBs. A valid quantity of PRBs may correspond to or otherwise be understood as a quantity of PRBs that is usable for scheduling communications between a UE 115 and a network entity 105. In accordance with such a light bandwidth adaptation mechanism, a set of baseband configurations may remain the same across the multiple subbands within an active BWP, leading to an avoidance of a “heavy” reconfiguration at a UE 115 when the UE 115 switches between subbands.

In accordance with each of the multiple subbands being configured with relatively smaller sets of unique parameters and otherwise being associated with the same parameters as the BWP, switching between subbands may involve a relatively “light” adaptation at a UE 115. Such a “light” adaptation may be associated with a relatively low cost at the UE 115 to store respective sets of parameters for each subband or a relatively low timeline/reprogramming cost at the UE 115 to reconfigure parameters each time a subband switch occurs. For example, in accordance with switching between subbands within an active BWP (such as adapting the bandwidth in accordance with the configuration of subbands and subband identifiers (IDs) within the active BWP), the UE 115 may reconfigure a relatively smaller quantity of parameters as compared to how many parameters the UE 115 may reconfigure in accordance with switching between BWPs, which may result in less down time per UE 115 and reduce penalties associated with a misalignment between a UE 115 and a network entity 105.

In some implementations, a UE 115 and a network entity 105 may support one or more signaling- or configuration-based mechanisms according to which the UE 115 and the network entity 105 are able to reconcile a misalignment regarding at which subband the UE 115 operates in scenarios in which the UE 115 supports multiple subbands within an active BWP. For example, the UE 115 may parse one or more DCI messages in accordance with each the multiple subbands within the active BWP including different valid quantities of PRBs. By way of further example, the UE 115 may receive a DCI message that includes scheduling information associated with a data message and that indicates an FDRA associated with the data message. The UE 115 may parse the DCI message to determine whether the FDRA includes one or more PRBs that are invalid for a subband at which the UE 115 operates and, if so, the UE 115 may transmit an uplink message to the network entity 105. The uplink message may include information associated with a detected subband misalignment between the UE and the network entity. Additionally, or alternatively, the uplink message may include an ACK or a NACK associated with the data message (depending on whether the UE is able to decode the scheduled data message, which may be possible in some types of subband misalignment). By reconciling subband mismatches in accordance with the described techniques, the UE 115 and the network entity 105 may experience greater communication reliability and reduced device power consumption, which may increase data rates and increase a battery life.

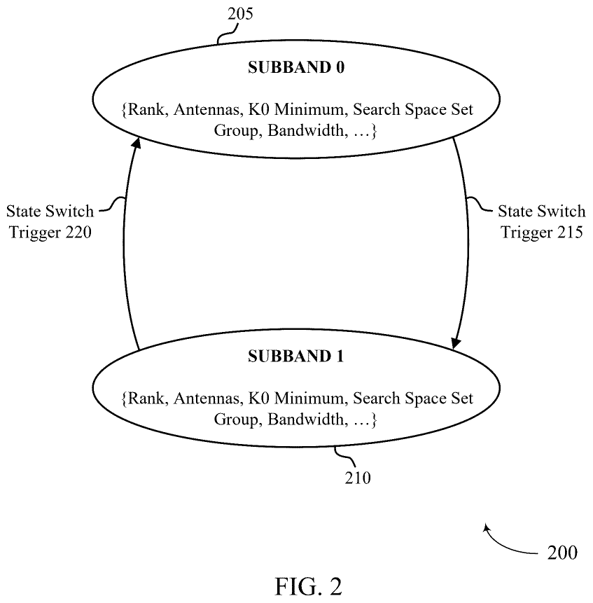

FIG. 2 shows an example of a subband configuration 200, of multiple subbands within an active BWP, that supports subband synchronization with light adaptation between subbands of an active BWP. The subband configuration 200 may implement or be implemented to realize or facilitate one or more aspects of the wireless communications system 100. For example, the subband configuration 200 may define a first subband 205 (illustrated in the example of FIG. 2 as a “subband 0”) and a second subband 210 (illustrated in the example of FIG. 2 as a “subband 1”). For example, a UE 115 and a network entity 105, such as a UE 115 and a network entity 105 as illustrated by and described with reference to FIG. 1, may support the subband configuration 200 to realize or facilitate one or more aspects of the present disclosure.

The first subband 205 and the second subband 210 may be associated with a set of parameters that is also associated with a BWP that includes the first subband 205 and the second subband 210. Additionally, in some examples, the first subband 205 and the second subband 210 may be associated with unique (and smaller) sets of parameters that are subband-specific. Such smaller sets of parameters that are subband-specific may include one or more of a (maximum) rank, a quantity of operated antennas (such as a quantity of active receive (Rx) or transmit (Tx) antennas), timeline parameters (such as a K0 minimum, which may be understood as a minimum scheduling offset), a search space set group (such as a search space periodicity, such as to replace search space set group switching without a possibility of changing CORESET), and a bandwidth, among other examples. For example, the first subband 205 may be associated with one or more of a first (maximum) rank, a first quantity of operated antennas, a first K0 minimum, a first search space set group, and a first bandwidth (such as a first valid quantity of PRBs). By way of further example, the second subband 210 may be associated with one or more of a second (maximum) rank, a second quantity of operated antennas, a second K0 minimum, a second search space set group, and a second bandwidth (such as a second valid quantity of PRBs).

In some aspects, the first subband 205 (which may be equivalently referred to herein as a first bandwidth or a first sub-BWP of a BWP) may be associated with a first communication configuration (such as a first state or mode) and the second subband 210 (which may be equivalently referred to herein as a second bandwidth or a second sub-BWP of a BWP) may be associated with a second communication configuration (such as a second state or mode). The first communication configuration may be associated with, indicate, define, or specify a first maximum bandwidth, a first minimum processing timeline, a first minimum scheduling offset, and/or a first maximum rank. The second communication configuration may be associated with, indicate, define, or specify a second maximum bandwidth, a second minimum processing timeline, a second minimum scheduling offset, and/or a second maximum rank. In examples in which the first subband 205 includes a relatively smaller valid quantity of PRBs as compared to the second subband 210, the first maximum bandwidth may be smaller than the second maximum bandwidth, the first minimum processing timeline may be longer than the second minimum processing timeline, the first minimum scheduling offset may be longer than the second minimum scheduling offset, or the first maximum rank may be relatively smaller than the second maximum rank. In some implementations, the UE 115 may switch between operation in accordance with the first communication configuration and the second communication configuration more quickly than switching between BWPs.

The UE 115 and the network entity 105 may support a subband switch trigger 215 to switch from the first subband 205 to the second subband 210 and may support a subband switch trigger 220 to switch from the second subband 210 to the first subband 205. Such switching triggers may be one or more of DCI-based, timer-based, or event-based, among other examples. In some aspects, subband switching may be accompanied with a scheduling delay, such that K0/K2 is greater than 0. Same slot scheduling may be possible according to active adaptation parameters (such as adaptation between subband-specific parameters).

In some implementations, scenarios may arise in which the UE 115 operates at the first subband 205 and the network entity 105 expects the UE 115 to operate at the second subband 210. Such scenarios may arise for one or more of various reasons, such as the UE 115 missing a DCI message that instructed the UE 115 to switch from the first subband 205 to the second subband 210. In such scenarios, the UE 115 may receive a DCI message that includes scheduling information associated with a data message with an FDRA that violates a scheduling expectation at the UE 115. For example, the FDRA of the data message may include one or more PRBs that are invalid for the first subband 205 (such as that exceed the first valid quantity of PRBs associated with the first subband 205). The UE 115 may parse the DCI message to determine (such as detect, identify, or otherwise ascertain) that the FDRA includes one or more PRBs that are invalid for the first subband 205 and that are valid for the second subband 210. In accordance with such a determination, the UE 115 may identify a mismatched (such as misaligned) subband scenario between the UE 115 and the network entity 105. The UE 115 may transmit an uplink message to the network entity 105 accordingly, which, in some implementations, may inform the network entity 105 of the mismatched subband scenario.

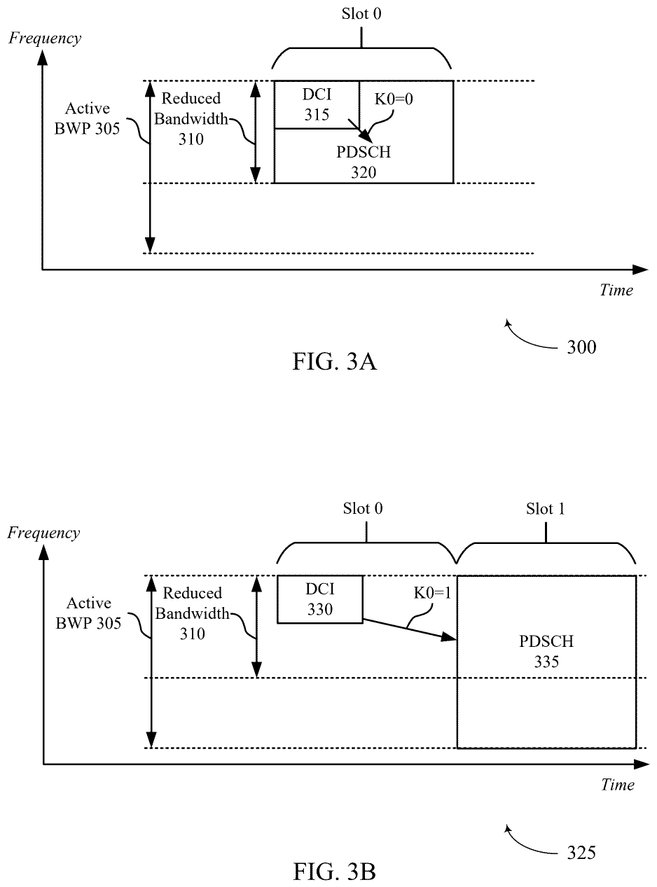

FIGS. 3A and 3B show examples of a communication timeline 300 and a communication timeline 325, respectively, in which a DCI message schedules a data message in accordance with light adaptation between subbands of an active BWP. The communication timeline 300 and the communication timeline 325 may implement or be implemented to realize or facilitate one or more aspects of the wireless communications system 100 or the subband configuration 200. For example, a UE 115 and a network entity 105, which may be examples of corresponding devices illustrated and described herein, may communicate in accordance with one or both of the communication timeline 300 and the communication timeline 325.

For example, the UE 115 and the network entity 105 may communicate via an active BWP 305. In some implementations, the UE 115 and the network entity 105 may support multiple subbands within the active BWP 305. In such implementations, a first subband (such as the first subband 205) may be associated with a first bandwidth (such as a first valid quantity of PRBs) and a second subband (such as the second subband 210) may be associated with a second bandwidth (such as a second valid quantity of PRBs). In some examples, the first bandwidth may be a reduced bandwidth 310 and the second bandwidth may be a full bandwidth of the active BWP 305. In such examples, the first subband may be a subset of the second subband. In other words, the first valid quantity of PRBs may be a subset of the second valid quantity of PRBs. The full bandwidth of the active BWP 305 may be understood or referred to as a carrier bandwidth.

In accordance with the communication timeline 300, the UE 115 may receive, from the network entity 105, a DCI message 315 that includes scheduling information associated with a data message (such as a downlink data message) to be communicated via a PDSCH 320. The DCI message 315 may indicate a slot offset (such as a scheduling offset) of K0=0, which may schedule the data message (such as the PDSCH 320) for a same slot within which the UE 115 receives the DCI message 315. In accordance with the example of the communication timeline 300, the UE 115 and the network entity 105 may operate at the first subband (such as the reduced bandwidth 310).

The first subband (such as the reduced bandwidth 310) may be associated with a scheduling restriction. For example, the UE 115 or the network entity 105 may use a scheduling restriction to adapt operation (such as to adapt bandwidth). By way of further example, a scheduled PDSCH or PUSCH that exceeds the reduced bandwidth 310 may be considered as an invalid grant in accordance with the UE 115 or the network entity 105 operating at the first subband. In some aspects, such a scheduling restriction may be timing-based such that, for example, the UE 115 or the network entity 105 may not expect the DCI message 315 to schedule a data message with an FDRA that exceeds the reduced bandwidth 310 within a threshold duration (such as a threshold K0 value, which may be a K0 value of 0) of the DCI message 315. If the data message is scheduled past the threshold duration (such as with a K0 value of 1 or greater), the UE 115 or the network entity 105 may allow the DCI message 315 to schedule a data message with an FDRA that exceeds the reduced bandwidth 310.

In accordance with the communication timeline 325, the UE 115 may receive, from the network entity 105, a DCI message 330 that includes scheduling information associated with a data message (such as a downlink data message) to be communicated via a PDSCH 335. The DCI message 330 may indicate a slot offset (such as a scheduling offset) of K0=1, which may schedule the data message (such as the PDSCH 335) for a next slot after the slot within which the UE 115 receives the DCI message 330. In accordance with the example of the communication timeline 325, the UE 115 and the network entity 105 may operate at the second subband (such as the full bandwidth of the active BWP 305), at least for communication (such as transmission or reception) of the data message.

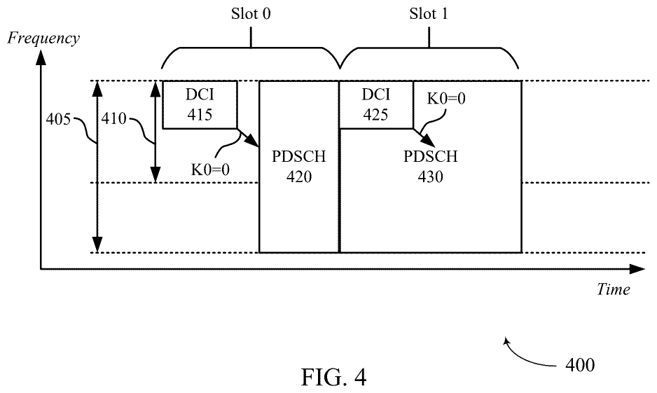

FIG. 4 shows an example of a communication timeline 400 in which a DCI message schedules a data message in accordance with light adaptation between subbands of an active BWP. The communication timeline 400 may implement or be implemented to realize or facilitate one or more aspects of the wireless communications system 100, the subband configuration 200, the communication timeline 300, or the communication timeline 325. For example, a UE 115 and a network entity 105, which may be examples of corresponding devices described herein, may communicate in accordance with the communication timeline 400.

For example, the UE 115 and the network entity 105 may communicate via an active BWP 405. In some implementations, the UE 115 and the network entity 105 may support multiple subbands within the active BWP 405. In such implementations, a first subband (such as the first subband 205) may be associated with a first bandwidth (such as a first valid quantity of PRBs) and a second subband (such as the second subband 210) may be associated with a second bandwidth (such as a second valid quantity of PRBs). In some examples, the first bandwidth may be a reduced bandwidth 410 and the second bandwidth may be a full bandwidth of the active BWP 405. In such examples, the first subband may be a subset of the second subband. In other words, the first valid quantity of PRBs may be a subset of the second valid quantity of PRBs. The full bandwidth of the active BWP 405 may be understood or referred to as a carrier bandwidth.

In accordance with the communication timeline 400, the UE 115 may receive, from the network entity 105, a DCI message 415 that includes scheduling information associated with a data message (such as a downlink data message) to be communicated via a PDSCH 420. The DCI message 415 may indicate a slot offset (such as a scheduling offset) of K0=0, which may schedule the data message (such as the PDSCH 420) for a same slot within which the UE 115 receives the DCI message 415. Additionally, the UE 115 may receive, from the network entity 105, a DCI message 425 that includes scheduling information associated with a data message (such as a downlink data message) to be communicated via a PDSCH 430. The DCI message 425 may indicate a slot offset (such as a scheduling offset) of K0=0, which may schedule the data message (such as the PDSCH 430) for a same slot within which the UE 115 receives the DCI message 425. In accordance with the example of the communication timeline 400, the UE 115 and the network entity 105 may operate at the second subband (such as the full bandwidth of the active BWP 405).

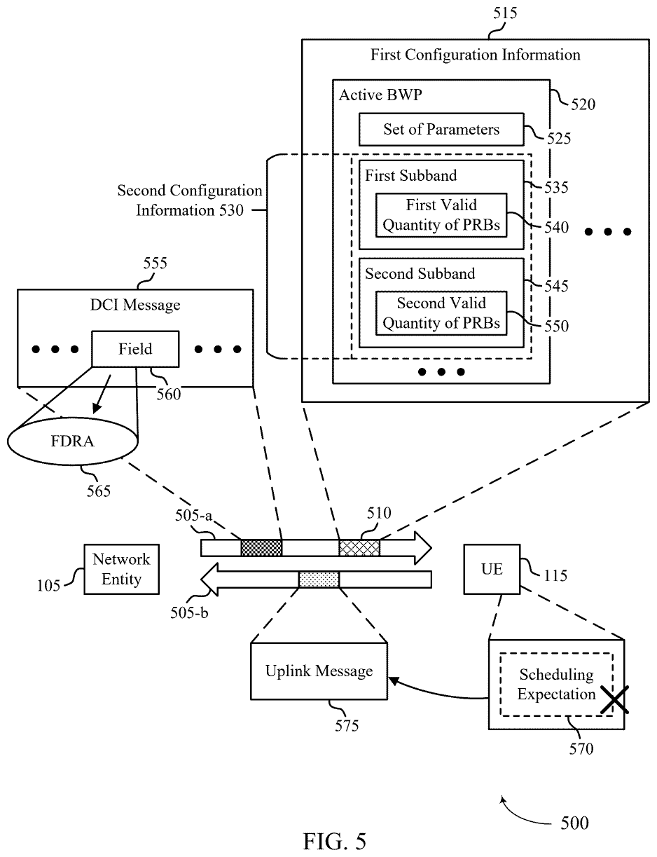

FIG. 5 shows an example of a signaling diagram 500 between a UE 115 and a network entity 105, in accordance with a scheduling expectation at the UE 115 associated with a subband at which the UE 115 operates, that supports subband synchronization with light adaptation between subbands of an active BWP. The signaling diagram 500 may implement or be implemented to realize or facilitate one or more aspects of the wireless communications system 100, the subband configuration 200, the communication timeline 300, the communication timeline 325, or the communication timeline 400. The UE 115 and the network entity 105, which may be examples of corresponding devices illustrated and described herein, may communicate via a communication link 505-a (such as a downlink) and a communication link 505-b (such as an uplink).

In some implementations, the UE 115 may receive control signaling 510 from the network entity 105 indicative of configuration information. Such control signaling 510 may include RRC signaling, one or more MAC control elements (MAC-CEs), one or more DCI messages, or any combination thereof. The signaling 510 may configure the UE 115 with one or more parameters associated with one or more BWPs and one or more subbands within each BWP. For example, the signaling 510 may indicate first configuration information 515 indicative of a set of parameters 525 associated with an active BWP 520 (such as a configured BWP that is used as an active BWP) and, as part of the first configuration information 515, second configuration information 530 indicative of a first subband 535 and a second subband 545 within the active BWP 520. The signaling 510 may indicate, configure, or define one or more other BWPs in addition to the active BWP 520 (including one or both of uplink BWPs and downlink BWPs) and may indicate, configure, or define whether a BWP includes multiple subbands on a per-BWP basis.

The set of parameters 525 may include any one or more parameters that are configured as being associated with the active BWP 520 and, in some aspects, may be inherited by or common to (such as universally applicable to) the first subband 535 and the second subband 545. For example, the set of parameters 525 may include one or more parameters associated with a BWP bandwidth (such as 20 MHz or 100 MHz, among other examples), one or more parameters associated with an SCS, one or more parameters associated with an MCS table, one or more parameters associated with a CSI configuration, one or more parameters associated with a maximum rank, one or more parameters associated with a CORESET, one or more parameters associated with an SRS configuration, one or more parameters associated with a CG configuration, one or more parameters associated with semi-persistently scheduled communications, one or more parameters associated with beam failure reporting, one or more parameters associated with RLM, or any combination thereof, among other examples of BWP-specific parameters. In some aspects, the set of parameters 525 may include one or more baseband parameters, such that configurations to baseband remain the same between subbands of the active BWP 520. Such baseband parameters may include CORESET and DCI size configurations. In accordance with maintaining the same baseband configurations across the subbands within the active BWP 520, the UE 115 may be reachable (by way of decodable DCI) regardless of at which subband the UE 115 operates (even in scenarios in which there is a subband mismatch between the UE 115 and the network entity 105).

The second configuration information 530 may indicate (such as define or configure) subbands within the active BWP 520 and provide a subband ID to each subband within the active BWP 520. For example, the second configuration information 530 may indicate an ID of 0 for the first subband 535 and may indicate an ID of 1 for the second subband 545. Subsequent signaling (such as one or more DCI messages) between the UE 115 and the network entity 105 may refer to the first subband 535 or the second subband 545 by subband ID. For example, a DCI message may include a field indicative of a subband ID (such as via which a scheduled data message is to be transmitted), which may increase a size of the DCI message as compared to DCI messages in systems unsupportive of multiple subbands within an active BWP.

In some implementations, the second configuration information 530 may indicate that the first subband 535 includes or is otherwise associated with a first valid quantity of PRBs 540 and that the second subband 545 includes or is otherwise associated with a second valid quantity of PRBs 550, among one or more other subband-specific parameters. In some examples, the first subband 535 (such as the first subband 205) may be associated with a relatively restricted or narrow bandwidth and the second subband 545 (such as the second subband 210) may be associated with a relatively wide bandwidth. In examples in which the first subband 535 is relatively narrower as compared to the second subband 545, the second valid quantity of PRBs 550 may be greater than the first valid quantity of PRBs 540. For example, the first valid quantity of PRBs 540 may be a subset of the second valid quantity of PRBs 550 (such that the first subband 535 may likewise be a subset of the second subband 545).

In some implementations, the UE 115 and the network entity 105 may support one or more signaling- or configuration-based mechanisms according to which the UE 115 and the network entity 105 may mitigate, address, handle, resolve, or reconcile subband mismatches (such as subband misalignments) between the UE 115 and the network entity 105. Such mechanisms may be associated with systems in which some DCI fields, such as an FDRA field, are independent of the bandwidth of a subband (such that these DCI fields may still be decodable even in scenarios of a subband mismatch). Additionally, some PDCCH monitoring occasions may be common between subbands within an active BWP, further supporting the decodability of DCI regardless of a subband mismatch. Such DCI and PDCCH characteristics of light adaptation may lead devices of some systems to incorrectly identify a data communication error instead of a scheduling error, which may worsen out-of-synchronization issues. Accordingly, in some implementations, the UE 115 may parse DCI messages to determine whether the UE 115 and the network entity 105 are out-of-synchronization and indicate out-of-synchronization information to the network entity 105 in accordance with the active BWP 520 including multiple subbands with different valid quantities of PRBs. The UE 115 and the network entity 105 may support mechanisms to mitigate, address, handle, resolve, or reconcile subband mismatches in scenarios in which a subband ID is explicitly indicated in a DCI message and in scenarios in which the subband ID is not explicitly indicated in the DCI message. By supporting such various scenarios, the UE 115 and the network entity 105 may further support greater communication reliability and higher data rates, among other benefits.

For example, the UE 115 may receive a DCI message 555 that includes scheduling information associated with a data message and includes a field 560 indicative of an FDRA 565 associated with the data message. Such scheduling information may include a time domain resource assignment (such as a slot offset), an FDRA, a subband ID, or a redundancy version, among other examples. For example, the DCI message 555 may be a scheduling DCI that schedules the data message. The FDRA 565 may indicate a set of frequency domain resources. For example, the FDRA 565 may indicate a set of PRBs. The UE 115 may parse the DCI message 555 in accordance with the different quantities of PRBs of the multiple subbands within the active BWP 520 to determine whether the DCI message 555 violates a scheduling expectation 570 at the UE 115. The UE 115 may set the scheduling expectation 570 in accordance with a subband at which the UE 115 operates. For example, the UE 115 may have a first scheduling expectation 570 in accordance with operating at the first subband 535 and may have a second scheduling expectation 570 in accordance with operating at the second subband 545. In some aspects, differences between the first scheduling expectation 570 and the second scheduling expectation 570 may be associated with at least one subband of the multiple subbands within the active BWP 520 being associated with a scheduling restriction. For example, the first subband 535 may be associated with a scheduling restriction (such as a restriction to not be scheduled with one or more PRBs outside of the first valid quantity of PRBs 540), which may inform the UE 115 of the first scheduling expectation 570.

In examples in which the UE 115 operates at the first subband 535 and in which the FDRA 565 indicates one or more PRBs that are invalid for the first subband 535, the FDRA 565 may violate the scheduling expectation 570 at the UE 115. In some scenarios, the one or more PRBs may be invalid for the first subband 535 and valid for the second subband 545, which may be indicative of a subband mismatch between the UE 115 and the network entity 105. The UE 115 may transmit an uplink message 575 in accordance with the violation of the scheduling expectation 570 at the UE 115. In other words, the UE 115 may transmit the uplink message 575 in accordance with the FDRA 565 indicating one or more PRBs that are invalid for the first subband 535 and in accordance with the UE 115 operating at the first subband 535. Such a violation of the scheduling expectation 570 at the UE 115 may be indicative of, or otherwise associated with or caused by, the UE 115 missing a previous DCI message that instructed the UE 115 to switch subbands within the active BWP 520.

Additionally, or alternatively, the UE 115 may transmit the uplink message 575 in accordance with a detection of one or more other scenarios. For example, the UE 115 may transmit the uplink message 575 in accordance with detecting any mismatch between a subband at which the UE 115 operates and a subband at which the network entity 105 schedules the data message. For example, the UE 115 may transmit the uplink message 575 in accordance with operating at the second subband 545 and the FDRA 565 indicating a set of PRBs entirely within the first subband 535, among other examples. The uplink message 575 may include information indicative of the subband mismatch, an ACK, or a NACK. The UE 115 may transmit the uplink message 575 via RRC signaling, one or more MAC-CEs, one or more UCI messages, or any combination thereof.

In association with transmitting the uplink message 575, the UE 115 may monitor for another DCI message to instruct the UE 115 to switch to another subband within the active BWP 520 or may (autonomously) switch to another subband within the active BWP 520 without waiting for another DCI message to instruct the UE 115 to switch to another subband. In some examples, the UE 115 may switch to another subband without assistance from the network entity 105 if the UE 115 is able to accurately determine at which subband the network entity 105 expects the UE 115 to operate. If the UE 115 is unable to accurately determine at which subband the network entity 105 expects the UE 115 to operate, the UE 115 may monitor for another DCI message to instruct the UE 115 to switch to another subband. By selectively switching between subbands in accordance with detecting a subband mismatch, the UE 115 may further support greater communication reliability with relatively lower signaling overhead by proactively (without further explicit signaling from the network entity 105) switching to a subband at which the network entity 105 assumes the UE 115 is operating.

In some implementations, the UE 115 may switch between subbands of the active BWP 520 in accordance with a timer. The UE 115 may receive information indicative of the timer from the network entity 105 (such as via configuration signaling or information, such as via RRC signaling) or may retrieve the timer from one or more memories associated with (such as accessible by) the UE 115. The UE 115 may start the timer and may transition to the first subband 535 (such as a relatively narrower or narrowest subband) at expiry of the timer. In some examples, the UE 115 may (re)start the timer each time the UE 115 receives a DCI message. In accordance with such implementations, the UE 115 may avoid scenarios in which the UE 115 unnecessarily operates at, for example, the second subband 545. Operation at the second subband 545 may be unnecessary within time periods for which the UE 115 is not scheduled with communication or is scheduled with communication within the first subband 535. Such use of a timer may enable the UE 115 to efficiently handle situations in which the DCI message 555 does not include an indication of a subband via a subband field and does not violate the scheduling expectation 570 of the UE 115, as the UE 115 may use the timer to switch back to the first subband 535 instead of waiting for a subband switching DCI message. The network entity 105 may maintain the timer in parallel with the UE 115 to maintain alignment regarding at which subband the UE 115 operates. By using the timer, the UE 115 may achieve greater power savings or otherwise consume power more efficiently and selectively without sacrificing synchronization between the UE 115 and the network entity 105.

Further, although some examples are described in the context of the DCI message 555 including an explicit indication of a subband via a subband field, the DCI message 555 may additionally, or alternatively, implicitly indicate a subband for the UE 115 to use via a slot offset value (such as a K0 value). For example, if a slot offset indicated by the DCI message 555 fails to satisfy a threshold slot offset, the DCI message 555 may implicitly indicate that the UE 115 is to operate at the first subband 535 or to stay at a current subband. By way of further example, if the slot offset indicated by the DCI message 555 satisfies the threshold slot offset, the DCI message 555 may implicitly indicate that the UE 115 is to operate at the second subband 545 or to switch to another subband.

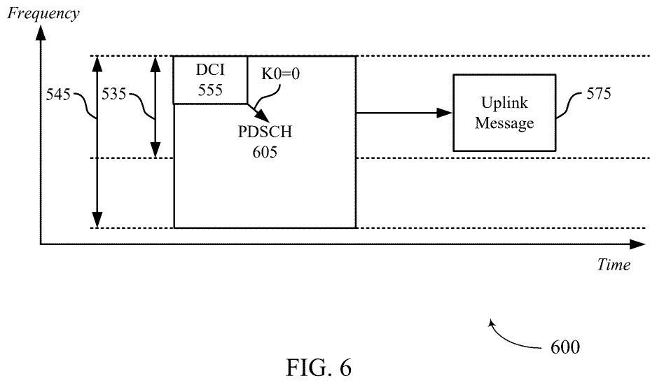

FIG. 6 shows an example of a communication timeline 600 in which a DCI message schedules a data message in accordance with light adaptation between subbands of an active BWP. The communication timeline 600 may implement or be implemented to realize or facilitate one or more aspects of the wireless communications system 100, the subband configuration 200, the communication timeline 300, the communication timeline 325, the communication timeline 400, or the signaling diagram 500. For example, a UE 115 and a network entity 105, which may be examples of corresponding devices illustrated and described herein, may communicate in accordance with the communication timeline 600.

In accordance with the communication timeline 600, the UE 115 and the network entity 105 may support the first subband 535 and the second subband 545 within the active BWP 520 and the UE 115 may receive, from the network entity 105, the DCI message 555 via a set of PDCCH resources of a CORESET associated with the active BWP 520. The DCI message 555 may schedule a downlink data message via a PDSCH 605 in accordance with the FDRA 565 indicated by the DCI message 555, as illustrated by and described with reference to FIG. 5.

In scenarios in which the UE 115 operates at the first subband 535 (such as a relatively narrower subband) and the DCI message 555 schedules the PDSCH with a set of PRBs associated with the second subband 545, the FDRA 565 may indicate one or more PRBs that are invalid for the first subband 535 and valid for the second subband 545. In other words, the FDRA 565 indicated by the DCI message 555 may be outside the limited bandwidth at which the UE 115 operates. In such examples, the UE 115 may be able to decode the DCI message 555 and may be unable to decode the PDSCH 605. In accordance with some example implementations, the UE 115 may inform the network entity 105 that the UE 115 is operating at a wrong (such as different) subband, such as via the uplink message 575.

In some implementations, the uplink message 575 may be a UCI message or another feedback message, such as a MAC-CE. In some examples, the uplink message 575 may be a feedback message that includes a multi-bit field. The multi-bit field may indicate one state of three or more possible states (such as a modified ACK or NACK that the UE 115 may use to convey three-state feedback). For example, the multi-bit field may indicate one of {ACK, NACK, irregular PDSCH}, with an indication of “irregular PDSCH” corresponding to an indication of a mismatched subband scenario between the UE 115 and the network entity 105. In other words, with an indication of “irregular PDSCH” may correspond to an indication of the FDRA 565 being not limited to a set of usable PRBs that the UE 115 considers to be valid for data reception within the first subband 535. In some aspects, a first value of the multi-bit field may correspond to “irregular PDSCH,” a second value of the multi-bit field may correspond to an ACK, and a third value of the multi-bit field may correspond to a NACK. In some examples, the multi-bit feedback field may include two bits.

Accordingly, in such scenarios in which the network entity 105 is operating at the second subband 545 and is expecting the UE 115 to operate at the second subband 545, but in which the UE 115 is operating at the first subband 535 with an insufficient K0 to switch from the first subband 535 to the second subband 545, the network entity 105 may expect an irregular PDSCH notification (such as via a dedicated UCI message on a PUCCH, such as triggered with a PUCCH resource indicator format 0, or a MAC-CE). Additionally, or alternatively, the network entity 105 may expect the UE 115 to transmit nothing, which may translate to a missed DCI, with single DCI. In some aspects, this may avoid scenarios in which the network entity 105 incorrectly assumes a data communication error and retransmits the data message with a next redundancy version (such as with a redundancy version of 2). In other words, in accordance with the DCI message 555 scheduling an invalid PDSCH outside of a subband at which the UE 115 operates, the UE 115 may transmit the uplink message 575 to indicate to the network entity 105 that the UE 115 is not expecting a PDSCH outside of a set of valid PRBs. In some examples, in accordance with receiving such an uplink message 575, the network entity 105 may schedule a retransmission of the data message with a redundancy version of 0 within the subband at which the UE 115 operates or within another subband after one or both of the UE 115 and the network entity 105 have switched.

In examples in which the DCI message 555 includes an indication of the second subband 545, the UE 115 may switch from the first subband 535 to the second subband 545 in accordance with transmitting the uplink message 575 or detecting the mismatched subband scenario. In examples in which the DCI message 555 does not include an indication of the second subband 545, the UE 115 may inform the network entity 105 of the mismatch via the uplink message 575 and may either switch to the second subband 545 (in accordance with determining that the FDRA 565 is associated with the second subband 545) or monitor for another DCI message instructing the UE 115 to switch to another subband within the active BWP 520. Thus, in accordance with aspects of the communication timeline 600, the UE 115 and the network entity 105 may efficiently achieve subband synchronization across various scenarios that may arise.

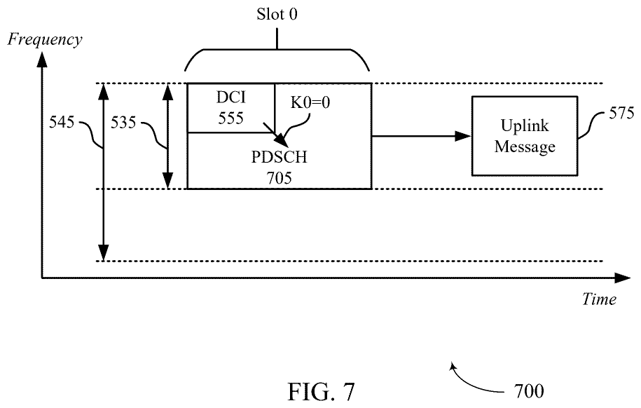

FIG. 7 shows an example of a communication timeline 700 in which a DCI message schedules a data message in accordance with light adaptation between subbands of an active BWP. The communication timeline 700 may implement or be implemented to realize or facilitate one or more aspects of the wireless communications system 100, the subband configuration 200, the communication timeline 300, the communication timeline 325, the communication timeline 400, or the signaling diagram 500. For example, a UE 115 and a network entity 105, which may be examples of corresponding devices illustrated and described herein, may communicate in accordance with the communication timeline 700.

In accordance with the communication timeline 700, the UE 115 and the network entity 105 may support the first subband 535 and the second subband 545 within the active BWP 520 and the UE 115 may receive, from the network entity 105, the DCI message 555 via a set of PDCCH resources of a CORESET associated with the active BWP 520. The DCI message 555 may schedule a downlink data message via a PDSCH 705 in accordance with the FDRA 565 indicated by the DCI message 555, as illustrated by and described with reference to FIG. 5.

In scenarios in which the UE 115 operates at the second subband 545 (such as a relatively wider subband) and the DCI message 555 includes an indication of the first subband 535 via a subband field and schedules the PDSCH 705 with a set of PRBs within the first subband 535, the UE 115 may be able to decode the PDSCH 705 (as the set of scheduled PRBs are within the second subband 545 at which the UE 115 operates). In some implementations, the UE 115 may determine that the UE 115 is operating in a relatively higher power state unnecessarily, as the UE 115 may operate at the first subband 535 and still be able to receive the PDSCH 705. In such implementations, the UE 115 may determine the subband mismatch from the subband ID included within the DCI message 555. The UE 115 may inform the network entity 105 that the UE 115 is operating at a wrong (such as different) subband, such as via the uplink message 575 (such as a UCI message or a MAC-CE).

Additionally, or alternatively, the UE 115 may include an ACK or a NACK within the uplink message 575 and switch from the second subband 545 to the first subband 535. For example, instead of providing information indicative of a mismatched subband scenario within the uplink message 575, the UE 115 may reduce signaling overhead by (only) including an ACK or a NACK within the uplink message 575 and resolving the mismatch by (autonomously) switching from the second subband 545 to the first subband 535 (without further coordination or signaling with the network entity 105). In such scenarios in which the UE 115 operates at the second subband 545 and the network entity 105 operates at the first subband 535, the network entity 105 may expect an ACK, a NACK (such as PDSCH not decoded, such as in accordance with a CRC fail) or a missed DCI if a multibit codebook is included), or nothing (with an absence of a responsive transmission by the UE 115 translating to or indicating a missed DCI).

In other scenarios in which the UE 115 operates at the first subband 535 (such as a relatively narrower subband) and the DCI message 555 includes an indication of the second subband 545 via a subband field but schedules the PDSCH 705 with a set of PRBs within the first subband 535, the FDRA 565 may violate the scheduling expectation 570 of the UE 115 with the scheduled downlink data message still being decodable by the UE 115 (in accordance with the downlink data message being scheduled within the first subband 535). In such scenarios, the UE 115 may be able to decode the PDSCH 705. In accordance with some example implementations, in addition to attempting to decode the PDSCH 705, the UE 115 may inform the network entity 105 that the UE 115 is operating at a wrong (such as different) subband, such as via the uplink message 575. In such examples, the uplink message 575 may be a UCI message or a MAC-CE that includes information indicative of a mismatched subband scenario (such as via a field or one or more bits). Information indicative of a mismatched subband scenario may include an indication, to the network entity 105, that the UE 115 has switched subbands to realign with the network entity 105. Additionally, or alternatively, the uplink message 575 may include an ACK or a NACK (depending on whether the UE 115 is able to successfully decode the PDSCH 705). Additionally, or alternatively, the UE 115 may switch from the first subband 535 to the second subband 545 in accordance with the DCI message 555 including the indication of the second subband 545. Thus, in accordance with aspects of the communication timeline 700, the UE 115 and the network entity 105 may efficiently achieve subband synchronization across various scenarios that may arise.

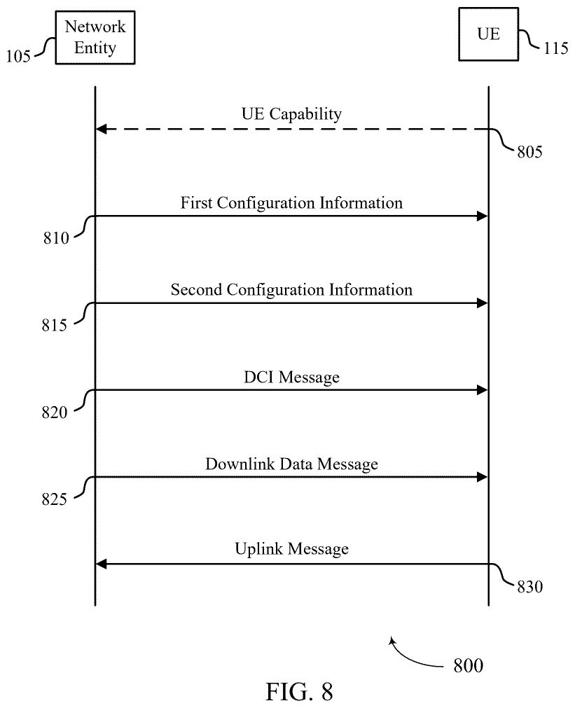

FIG. 8 shows an example of a process flow 800 illustrative of signaling between a UE 115 and a network entity 105 that supports subband synchronization with light adaptation between subbands of an active BWP. The process flow 800 may implement or be implemented to realize or facilitate one or more aspects of the wireless communications system 100, the subband configuration 200, the communication timeline 300, the communication timeline 325, the communication timeline 400, the signaling diagram 500, the communication timeline 600, or the communication timeline 700. The UE 115 and the network entity 105 may be examples of corresponding devices as illustrated and described herein.

In the following description of the process flow 800, the communications between the UE 115 and the network entity 105 may be transmitted in a different order than the example order shown, or the operations performed by the UE 115 and the network entity 105 may be performed in different orders or at different times. Some operations may also be omitted from the process flow 800, and other operations may be added to the process flow 800.

At 805, the UE 115 may transmit information indicative of a UE capability to the network entity 105. Such information may indicate whether the UE 115 is capable of supporting multiple subbands within an active BWP, timeline (such as slot offset) or processing capabilities of the UE 115, or field interpretations supported by the UE 115, among other examples. The UE 115 may transmit such information indicative of the UE capability via RRC signaling, one or more MAC-CEs, UCI, or any combination thereof.

At 810, the UE 115 may receive, from the network entity 105, first configuration information. The first configuration information that the UE 115 receives at 810 may be an example of the first configuration information 515 as illustrated by and described with reference to FIG. 5. The first configuration information may indicate a respective set of parameters associated with each BWP of one or more BWPs configured at the UE 115, including a set of parameters associated with an active BWP of the UE 115 (such as the set of parameters 525 associated with the active BWP 520 as illustrated by and described with reference to FIG. 5).

At 815, the UE 115 may receive, from the network entity 105, second configuration information. The second configuration information that the UE 115 receives at 815 may be an example of the second configuration information 530 as illustrated by and described with reference to FIG. 5. The second configuration information may indicate multiple subbands of different valid quantities of PRBs within the active BWP. For example, the UE 115 may receive the second configuration information as part of (such as within) the first configuration information. In other words, the first configuration information may include a set of parameters, fields, or information elements, with a subset of the set of parameters, fields, or information elements providing the second configuration information. The multiple subbands with the different valid quantities of PRBs may include the first subband 535 and the second subband 545, as illustrated by and described with reference to FIGS. 5, 6, and 7.

At 820, the UE 115 may receive, from the network entity 105, a DCI message. The DCI message that the UE 115 receives at 820 may be an example of the DCI message 555 as illustrated by and described with reference to FIG. 5. The DCI message may schedule a data message and may include a field that indicates an FDRA associated with the data message. The UE 115 may determine whether the FDRA associated with the data message violates a scheduling expectation at the UE 115. For example, the UE 115 may parse the DCI message to determine whether the FDRA includes one or more PRBs that are invalid for the first subband and valid for the second subband.

At 825, the UE 115 may receive, from the network entity 105, the downlink data message. The UE 115 may receive the downlink data message in accordance with the FDRA indicated by the field of the DCI message. For example, the UE 115 may receive the downlink data message via a set of frequency domain resources indicated by the FDRA. Further, although some example implementations are described and shown in the context of a scheduled downlink data message, the data message scheduled by the DCI message may be a downlink data message or an uplink data message without exceeding the scope of the present disclosure. Thus, more generally, the UE 115 may communicate the data message with (such as transmit the data message to or receive the data message from) the network entity 105 in accordance with the FDRA indicated by the DCI message.

At 830, the UE 115 may transmit an uplink message to the network entity 105. The uplink message that the UE 115 transmits at 830 may be an example of the uplink message 575 as illustrated by and described with reference to FIGS. 5, 6, and 7. The uplink message may be a UCI message or a MAC-CE. The uplink message may include information indicative of a mismatched subband scenario, an ACK associated with the downlink data message, or a NACK associated with the downlink data message. In accordance with transmitting the uplink message or detecting a mismatched subband scenario, the UE 115 may switch from one subband to another subband. For example, the UE 115 may switch from the first subband to the second subband in accordance with determining that the FDRA includes one or more PRBs that are invalid for the first subband and valid for the second subband.

Additionally, in some aspects, the network entity 105 may support one or more mechanisms according to which the network entity 105 may switch subbands to realign with the UE 115. For example, if the network entity 105 has reached a maximum quantity of retransmissions of a data message, the network entity 105 may determine to switch subbands without a response from the UE 115 (such as without an irregular PDSCH notification, an ACK, or a NACK). In accordance with a subband switch by the network entity 105, the UE 115 may decode DCI messages in some monitoring occasions after the switch, which may result in a less severe out-of-synchronization scenario.

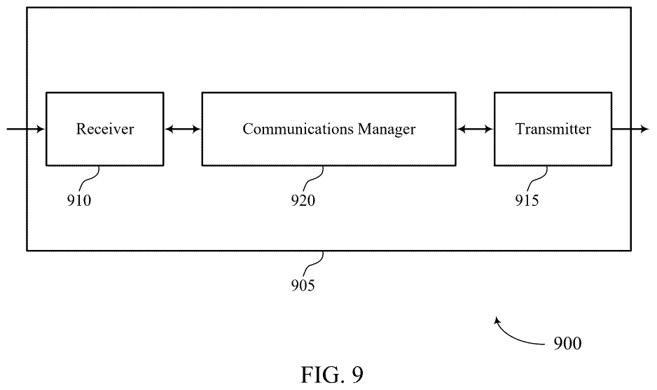

FIG. 9 shows a block diagram 900 of a device 905 that supports subband synchronization with light adaptation between subbands of an active BWP. The device 905 may be an example of aspects of a UE 115 as described herein. The device 905 may include a receiver 910, a transmitter 915, and a communications manager 920. The device 905, or one or more components of the device 905 (such as the receiver 910, the transmitter 915, the communications manager 920), may include at least one processor, which may be coupled with at least one memory, to, individually or collectively, support or enable the described techniques. Each of these components may be in communication with one another (such as via one or more buses).

The receiver 910 may provide a means for receiving information such as packets, user data, control information, or any combination thereof associated with various information channels (such as control channels, data channels, information channels related to subband synchronization with light adaptation between subbands of an active BWP). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (such as control channels, data channels, information channels related to subband synchronization with light adaptation between subbands of an active BWP). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of subband synchronization with light adaptation between subbands of an active BWP as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (such as in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (such as by one or more processors, individually or collectively, executing instructions stored in the at least one memory).

Additionally, or alternatively, the communications manager 920, the receiver 910, the transmitter 915, or various combinations or components thereof may be implemented in code (as communications management software or firmware) executed by at least one processor (such as referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (such as configured as or otherwise supporting, individually or collectively, a means for performing the functions described in the present disclosure).

In some examples, the communications manager 920 may be configured to perform various operations (such as receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. For example, the communications manager 920 is capable of, configured to, or operable to support a means for receiving first configuration information indicative of a set of parameters associated with an active BWP of the UE and, as part of the first configuration information, second configuration information indictive of at least a first subband that includes a first valid quantity of PRBs and a second subband that includes a second valid quantity of PRBs. The communications manager 920 is capable of, configured to, or operable to support a means for receiving a first DCI message that indicates an FDRA associated with a downlink data message, the FDRA including one or more PRBs that are invalid for the first subband and valid for the second subband. The communications manager 920 is capable of, configured to, or operable to support a means for transmitting an uplink message in accordance with the FDRA including the one or more PRBs.

By including or configuring the communications manager 920 in accordance with examples as described herein, the device 905 (such as at least one processor controlling or otherwise coupled with the receiver 910, the transmitter 915, the communications manager 920, or a combination thereof) may support techniques for reduced processing, reduced power consumption, and more efficient utilization of communication resources. For example, light adaptation mechanisms may involve time, frequency, and antenna adaptation that saves device energy without the relatively higher cost associated with BWP switches (which may involve a relatively high penalty for active BWP misalignment between a UE 115 and a network entity 105 and a relatively long switching time).

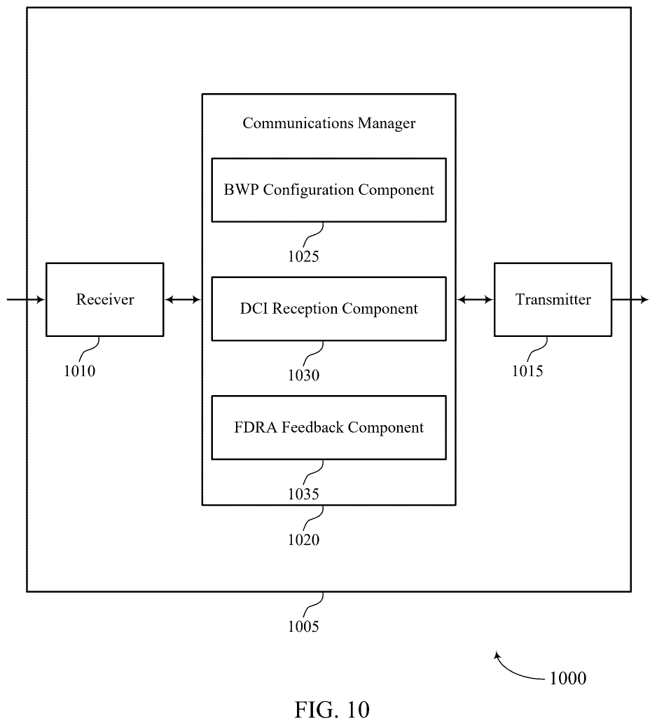

FIG. 10 shows a block diagram 1000 of a device 1005 that supports subband synchronization with light adaptation between subbands of an active BWP. The device 1005 may be an example of aspects of a device 905 or a UE 115 as described herein. The device 1005 may include a receiver 1010, a transmitter 1015, and a communications manager 1020. The device 1005, or one or more components of the device 1005 (such as the receiver 1010, the transmitter 1015, the communications manager 1020), may include at least one processor, which may be coupled with at least one memory, to support the described techniques. Each of these components may be in communication with one another (such as via one or more buses).

The receiver 1010 may provide a means for receiving information such as packets, user data, control information, or any combination thereof associated with various information channels (such as control channels, data channels, information channels related to subband synchronization with light adaptation between subbands of an active BWP). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (such as control channels, data channels, information channels related to subband synchronization with light adaptation between subbands of an active BWP). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of subband synchronization with light adaptation between subbands of an active BWP as described herein. For example, the communications manager 1020 may include a BWP configuration component 1025, a DCI reception component 1030, an FDRA feedback component 1035, or any combination thereof. The communications manager 1020 may be an example of aspects of a communications manager 920 as described herein. In some examples, the communications manager 1020, or various components thereof, may be configured to perform various operations (such as receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. The BWP configuration component 1025 is capable of, configured to, or operable to support a means for receiving first configuration information indicative of a set of parameters associated with an active BWP of the UE and, as part of the first configuration information, second configuration information indictive of at least a first subband that includes a first valid quantity of PRBs and a second subband that includes a second valid quantity of PRBs. The DCI reception component 1030 is capable of, configured to, or operable to support a means for receiving a first DCI message that indicates an FDRA associated with a downlink data message, the FDRA including one or more PRBs that are invalid for the first subband and valid for the second subband. The FDRA feedback component 1035 is capable of, configured to, or operable to support a means for transmitting an uplink message in accordance with the FDRA including the one or more PRBs.

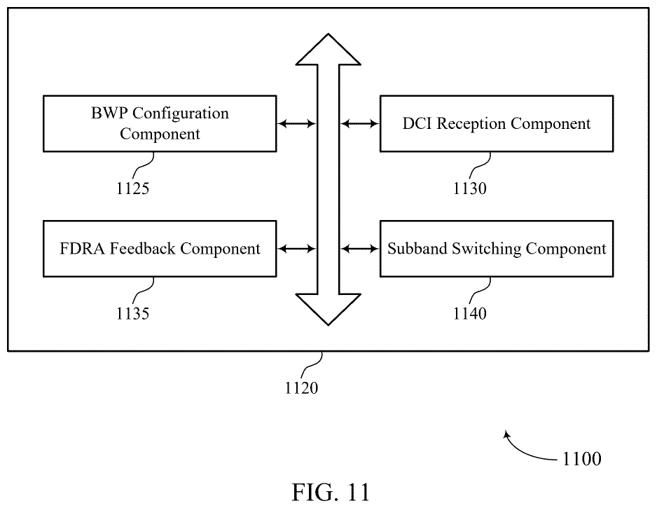

FIG. 11 shows a block diagram 1100 of a communications manager 1120 that supports subband synchronization with light adaptation between subbands of an active BWP. The communications manager 1120 may be an example of aspects of a communications manager 920, a communications manager 1020, or both, as described herein. The communications manager 1120, or various components thereof, may be an example of means for performing various aspects of subband synchronization with light adaptation between subbands of an active BWP as described herein. For example, the communications manager 1120 may include a BWP configuration component 1125, a DCI reception component 1130, an FDRA feedback component 1135, a subband switching component 1140, or any combination thereof. Each of these components, or components or subcomponents thereof (such as one or more processors, one or more memories), may communicate, directly or indirectly, with one another (such as via one or more buses).

The communications manager 1120 may support wireless communication in accordance with examples as disclosed herein. The BWP configuration component 1125 is capable of, configured to, or operable to support a means for receiving first configuration information indicative of a set of parameters associated with an active BWP of the UE and, as part of the first configuration information, second configuration information indictive of at least a first subband that includes a first valid quantity of PRBs and a second subband that includes a second valid quantity of PRBs. The DCI reception component 1130 is capable of, configured to, or operable to support a means for receiving a first DCI message that indicates an FDRA associated with a downlink data message, the FDRA including one or more PRBs that are invalid for the first subband and valid for the second subband. The FDRA feedback component 1135 is capable of, configured to, or operable to support a means for transmitting an uplink message in accordance with the FDRA including the one or more PRBs.

In some examples, the UE operates at the first subband at a reception time of the first DCI message. In some examples, the FDRA is not limited to a set of usable PRBs that the UE considers to be valid for data reception within the first subband in accordance with the FDRA including the one or more PRBs that are invalid for the first subband and valid for the second subband.

In some examples, the uplink message includes a negative acknowledgment. In some examples, the UE switches to the second subband in accordance with the FDRA including the one or more PRBs that are valid for the second subband.

In some examples, the uplink message includes an indication that the FDRA is not limited to the set of usable PRBs that the UE considers to be valid for the data reception within the first subband. In some examples, the UE switches to the second subband in accordance with the FDRA including the one or more PRBs that are valid for the second subband.

In some examples, the uplink message includes an uplink control information message or a medium access control (MAC) control element (MAC-CE). In some examples, a field associated with indicating mismatched subband scenarios within the uplink control information message or the MAC-CE includes the indication that the FDRA is not limited to the set of usable PRBs that the UE considers to be valid for the data reception within the first subband.

In some examples, the uplink message includes a feedback message. In some examples, a multi-bit field within the feedback message includes the indication that the FDRA is not limited to the set of usable PRBs that the UE considers to be valid for the data reception within the first subband.

In some examples, a first value of the multi-bit field within the feedback message corresponds to the indication of the FDRA being not limited to the set of usable PRBs that the UE considers to be valid for the data reception within the first subband; a second value of the multi-bit field within the feedback message corresponds to a positive acknowledgment associated with the downlink data message; and a third value of the multi-bit field within the feedback message corresponds to a negative acknowledgment associated with the downlink data message.

In some examples, the one or more PRBs of the FDRA are valid for the second subband in accordance with the first DCI message including an indication of the second subband or the FDRA failing to satisfy a scheduling restriction associated with the first subband.

In some examples, the subband switching component 1140 is capable of, configured to, or operable to support a means for switching from the first subband to the second subband in accordance with the first DCI message including an indication of the second subband.

In some examples, the DCI reception component 1130 is capable of, configured to, or operable to support a means for receiving a second DCI message in accordance with transmitting the uplink message, the second DCI message indicating the UE to switch from the first subband to the second subband.

In some examples, the DCI reception component 1130 is capable of, configured to, or operable to support a means for receiving a second DCI message prior to the first DCI message, the second DCI message indicating that the UE is to operate at the first subband, and a scheduling expectation being set at the UE in accordance with the second DCI message indicating that the UE is to operate at the first subband.

In some examples, the UE determines that the UE missed a third DCI message, between the second DCI message and the first DCI message, indicating the UE to switch from the first subband to the second subband in accordance with the FDRA including the one or more PRBs that are invalid for the first subband and valid for the second subband.

In some examples, the set of parameters is associated with the active BWP and both of the first subband and the second subband. In some examples, the set of parameters includes one or more of one or more first parameters associated with a control resource set; one or more second parameters associated with a sounding reference signal configuration; one or more third parameters associated with configured grant communications; and one or more fourth parameters associated with semi-persistently scheduled communications.

In some examples, the UE receives the first DCI message via a set of downlink control channel resources associated with the control resource set.

In some examples, the first valid quantity of PRBs defines a first set of one or more PRBs that are usable for scheduling within the first subband. In some examples, the second valid quantity of PRBs defines a second set of one or more PRBs that are usable for scheduling within the second subband.

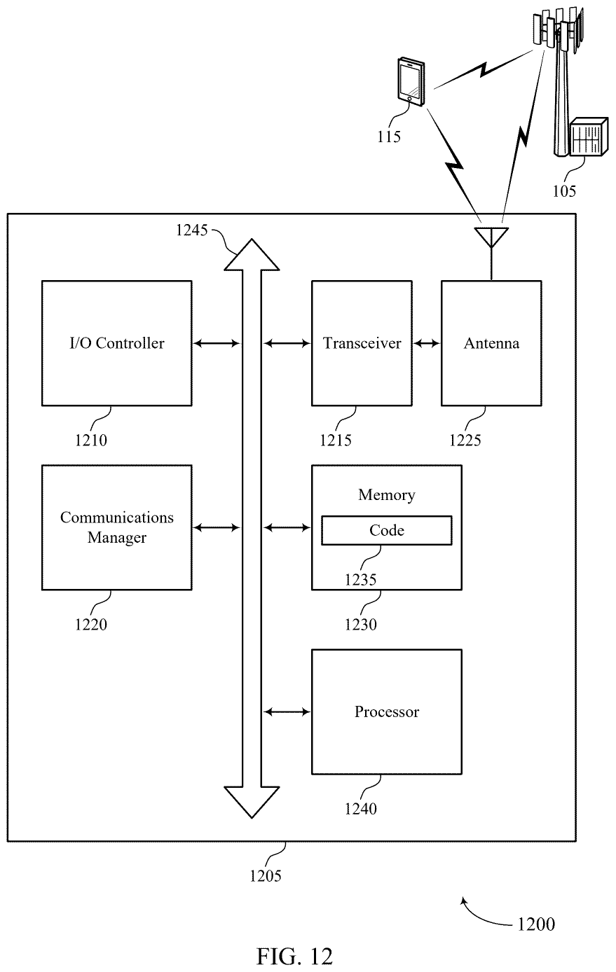

FIG. 12 shows a diagram of a system 1200 including a device 1205 that supports subband synchronization with light adaptation between subbands of an active BWP. The device 1205 may be an example of or include components of a device 905, a device 1005, or a UE 115 as described herein. The device 1205 may communicate (such as wirelessly) with one or more other devices (such as network entities 105, UEs 115, or a combination thereof). The device 1205 may include components for bi-directional voice and data communications including components for transmitting and receiving communications, such as a communications manager 1220, an input/output (I/O) controller, such as an I/O controller 1210, a transceiver 1215, one or more antennas 1225, at least one memory 1230, code 1235, and at least one processor 1240. These components may be in electronic communication or otherwise coupled (such as operatively, communicatively, functionally, electronically, electrically) via one or more buses (such as a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (such as when compiled and executed) to perform functions described herein. In some cases, the at least one memory 1230 may include, among other things, a basic I/O system (BIOS) which may control basic hardware or software operation such as the interaction with peripheral components or devices.

The at least one processor 1240 may include one or more intelligent hardware devices (such as one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (such as the at least one memory 1230) to cause the device 1205 to perform various functions (such as functions or tasks supporting subband synchronization with light adaptation between subbands of an active BWP). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (such as processor-executable code) stored in the at least one memory 1230 or otherwise, to perform one or more of the functions described herein. In some implementations, one or more of the multiple memories may be configured to store processor-executable code that, when executed, may configure one or more of the multiple processors to perform various functions described herein (as part of a processing system). In some other implementations, the processing system may be pre-configured to perform various functions described herein.

The processing system of the device 1205 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

The communications manager 1220 may support wireless communication in accordance with examples as disclosed herein. For example, the communications manager 1220 is capable of, configured to, or operable to support a means for receiving first configuration information indicative of a set of parameters associated with an active BWP of the UE and, as part of the first configuration information, second configuration information indictive of at least a first subband that includes a first valid quantity of PRBs and a second subband that includes a second valid quantity of PRBs. The communications manager 1220 is capable of, configured to, or operable to support a means for receiving a first DCI message that indicates an FDRA associated with a downlink data message, the FDRA including one or more PRBs that are invalid for the first subband and valid for the second subband. The communications manager 1220 is capable of, configured to, or operable to support a means for transmitting an uplink message in accordance with the FDRA including the one or more PRBs.

By including or configuring the communications manager 1220 in accordance with examples as described herein, the device 1205 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1220 may be configured to perform various operations (such as receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of subband synchronization with light adaptation between subbands of an active BWP as described herein, or the at least one processor 1240 and the at least one memory 1230 may be otherwise configured to, individually or collectively, perform or support such operations.

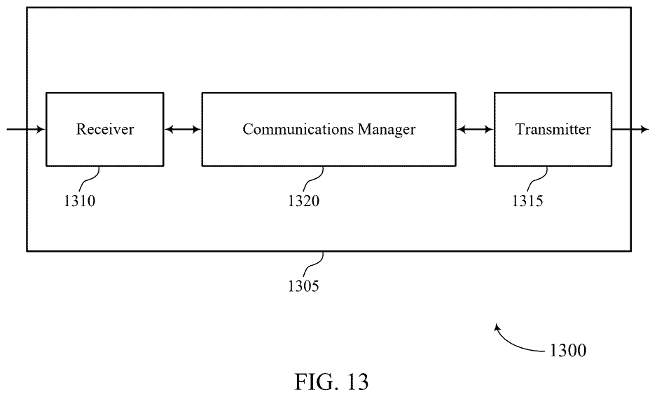

FIG. 13 shows a block diagram 1300 of a device 1305 that supports subband synchronization with light adaptation between subbands of an active BWP. The device 1305 may be an example of aspects of a network entity 105 as described herein. The device 1305 may include a receiver 1310, a transmitter 1315, and a communications manager 1320. The device 1305, or one or more components of the device 1305 (such as the receiver 1310, the transmitter 1315, the communications manager 1320), may include at least one processor, which may be coupled with at least one memory, to, individually or collectively, support or enable the described techniques. Each of these components may be in communication with one another (such as via one or more buses).

The receiver 1310 may provide a means for obtaining (such as receiving, determining, identifying) information such as user data, control information, or any combination thereof (such as I/Q samples, symbols, packets, protocol data units, service data units) associated with various channels (such as control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (such as electrical, fiber optic) interfaces, wireless interfaces, or any combination thereof.

The transmitter 1315 may provide a means for outputting (such as transmitting, providing, conveying, sending) information generated by other components of the device 1305. For example, the transmitter 1315 may output information such as user data, control information, or any combination thereof (such as I/Q samples, symbols, packets, protocol data units, service data units) associated with various channels (such as control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (such as electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations or components thereof may be examples of means for performing various aspects of subband synchronization with light adaptation between subbands of an active BWP as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (such as in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (such as by one or more processors, individually or collectively, executing instructions stored in the at least one memory).

Additionally, or alternatively, the communications manager 1320, the receiver 1310, the transmitter 1315, or various combinations or components thereof may be implemented in code (as communications management software or firmware) executed by at least one processor (such as referred to as a processor-executable code). If implemented in code executed by at least one processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (such as configured as or otherwise supporting, individually or collectively, a means for performing the functions described in the present disclosure).

In some examples, the communications manager 1320 may be configured to perform various operations (such as receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication in accordance with examples as disclosed herein. For example, the communications manager 1320 is capable of, configured to, or operable to support a means for outputting first configuration information indicative of a set of parameters associated with an active BWP of a UE and, as part of the first configuration information, second configuration information indictive of at least a first subband that includes a first valid quantity of PRBs and a second subband that includes a second valid quantity of PRBs. The communications manager 1320 is capable of, configured to, or operable to support a means for outputting a first DCI message that indicates an FDRA associated with a downlink data message, the FDRA including one or more PRBs that are invalid for the first subband and valid for the second subband. The communications manager 1320 is capable of, configured to, or operable to support a means for obtaining an uplink message in accordance with the FDRA including the one or more PRBs.

By including or configuring the communications manager 1320 in accordance with examples as described herein, the device 1305 (such as at least one processor controlling or otherwise coupled with the receiver 1310, the transmitter 1315, the communications manager 1320, or a combination thereof) may support techniques for reduced processing, and reduced power consumption, more efficient utilization of communication resources. For example, light adaptation mechanisms may involve time, frequency, and antenna adaptation that saves device energy without the relatively higher cost associated with BWP switches (which may involve a relatively high penalty for active BWP misalignment between a UE 115 and a network entity 105 and a relatively long switching time).

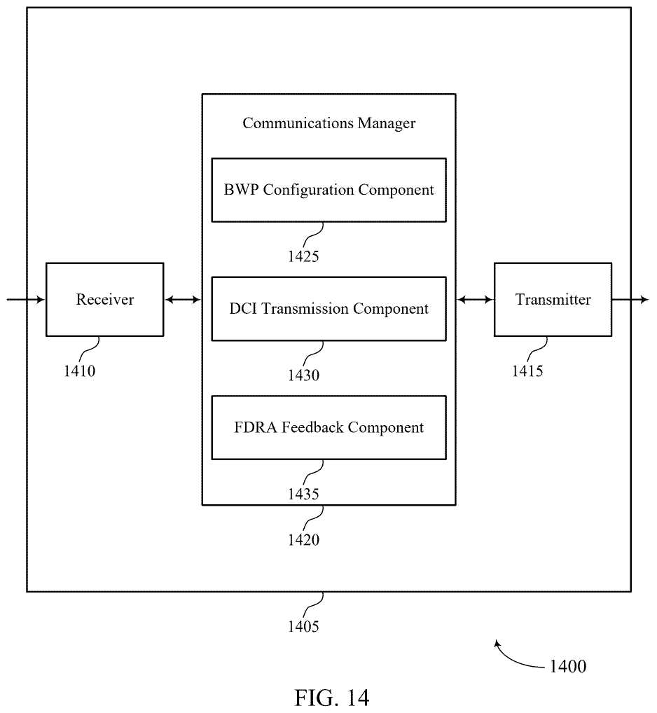

FIG. 14 shows a block diagram 1400 of a device 1405 that supports subband synchronization with light adaptation between subbands of an active BWP. The device 1405 may be an example of aspects of a device 1305 or a network entity 105 as described herein. The device 1405 may include a receiver 1410, a transmitter 1415, and a communications manager 1420. The device 1405, or one or more components of the device 1405 (such as the receiver 1410, the transmitter 1415, the communications manager 1420), may include at least one processor, which may be coupled with at least one memory, to support the described techniques. Each of these components may be in communication with one another (such as via one or more buses).

The receiver 1410 may provide a means for obtaining (such as receiving, determining, identifying) information such as user data, control information, or any combination thereof (such as I/Q samples, symbols, packets, protocol data units, service data units) associated with various channels (such as control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (such as electrical, fiber optic) interfaces, wireless interfaces, or any combination thereof.

The transmitter 1415 may provide a means for outputting (such as transmitting, providing, conveying, sending) information generated by other components of the device 1405. For example, the transmitter 1415 may output information such as user data, control information, or any combination thereof (such as I/Q samples, symbols, packets, protocol data units, service data units) associated with various channels (such as control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (such as electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of subband synchronization with light adaptation between subbands of an active BWP as described herein. For example, the communications manager 1420 may include a BWP configuration component 1425, a DCI transmission component 1430, an FDRA feedback component 1435, or any combination thereof. The communications manager 1420 may be an example of aspects of a communications manager 1320 as described herein. In some examples, the communications manager 1420, or various components thereof, may be configured to perform various operations (such as receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication in accordance with examples as disclosed herein. The BWP configuration component 1425 is capable of, configured to, or operable to support a means for outputting first configuration information indicative of a set of parameters associated with an active BWP of a UE and, as part of the first configuration information, second configuration information indictive of at least a first subband that includes a first valid quantity of PRBs and a second subband that includes a second valid quantity of PRBs. The DCI transmission component 1430 is capable of, configured to, or operable to support a means for outputting a first DCI message that indicates an FDRA associated with a downlink data message, the FDRA including one or more PRBs that are invalid for the first subband and valid for the second subband. The FDRA feedback component 1435 is capable of, configured to, or operable to support a means for obtaining an uplink message in accordance with the FDRA including the one or more PRBs.

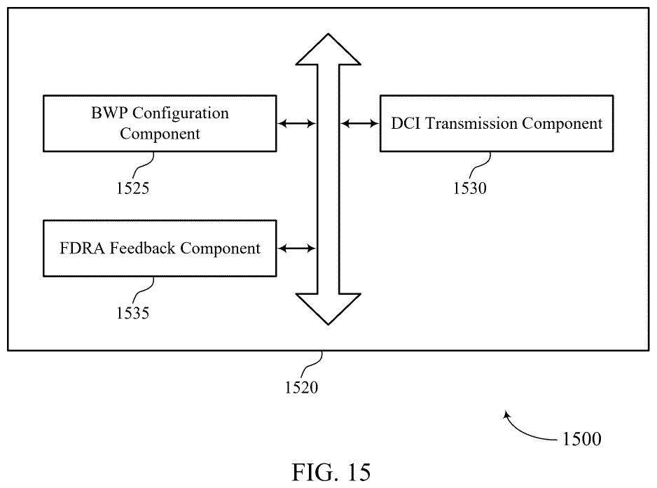

FIG. 15 shows a block diagram 1500 of a communications manager 1520 that supports subband synchronization with light adaptation between subbands of an active BWP. The communications manager 1520 may be an example of aspects of a communications manager 1320, a communications manager 1420, or both, as described herein. The communications manager 1520, or various components thereof, may be an example of means for performing various aspects of subband synchronization with light adaptation between subbands of an active BWP as described herein. For example, the communications manager 1520 may include a BWP configuration component 1525, a DCI transmission component 1530, an FDRA feedback component 1535, or any combination thereof. Each of these components, or components or subcomponents thereof (such as one or more processors, one or more memories), may communicate, directly or indirectly, with one another (such as via one or more buses). The communications may include communications within a protocol layer of a protocol stack, communications associated with a logical channel of a protocol stack (such as between protocol layers of a protocol stack, within a device, component, or virtualized component associated with a network entity 105, between devices, components, or virtualized components associated with a network entity 105), or any combination thereof.

The communications manager 1520 may support wireless communication in accordance with examples as disclosed herein. The BWP configuration component 1525 is capable of, configured to, or operable to support a means for outputting first configuration information indicative of a set of parameters associated with an active BWP of a UE and, as part of the first configuration information, second configuration information indictive of at least a first subband that includes a first valid quantity of PRBs and a second subband that includes a second valid quantity of PRBs. The DCI transmission component 1530 is capable of, configured to, or operable to support a means for outputting a first DCI message that indicates an FDRA associated with a downlink data message, the FDRA including one or more PRBs that are invalid for the first subband and valid for the second subband. The FDRA feedback component 1535 is capable of, configured to, or operable to support a means for obtaining an uplink message in accordance with the FDRA including the one or more PRBs.

In some examples, the uplink message includes a negative acknowledgment in accordance with the FDRA including the one or more PRBs that are invalid for the first subband and valid for the second subband. In some examples, the network entity expects the UE to switch to the second subband in accordance with the FDRA including the one or more PRBs that are valid for the second subband.

In some examples, the uplink message includes an indication that the FDRA is not limited to a set of usable PRBs that the UE considers to be valid for data reception within the first subband. In some examples, the network entity expects the UE to switch to the second subband in accordance with the FDRA including the one or more PRBs that are valid for the second subband.

In some examples, the uplink message includes an uplink control information message or a medium access control (MAC) control element (MAC-CE). In some examples, a field associated with indicating mismatched subband scenarios within the uplink control information message or the MAC-CE includes the indication that the FDRA is not limited to the set of usable PRBs that the UE considers to be valid for the data reception within the first subband.

In some examples, the uplink message includes a feedback message. In some examples, a multi-bit field within the feedback message includes the indication that the FDRA is not limited to the set of usable PRBs that the UE considers to be valid for the data reception within the first subband.

In some examples, a first value of the multi-bit field within the feedback message corresponds to the indication of the FDRA being not limited to the set of usable PRBs that the UE considers to be valid for the data reception within the first subband; a second value of the multi-bit field within the feedback message corresponds to a positive acknowledgment associated with the downlink data message; and a third value of the multi-bit field within the feedback message corresponds to a negative acknowledgment associated with the downlink data message.

In some examples, the one or more PRBs of the FDRA are valid for the second subband in accordance with the first DCI message including an indication of the second subband or the FDRA failing to satisfy a scheduling restriction associated with the first subband.

In some examples, the DCI transmission component 1530 is capable of, configured to, or operable to support a means for outputting a second DCI message in accordance with obtaining the uplink message, the second DCI message indicating the UE to switch from the first subband to the second subband.

In some examples, the DCI transmission component 1530 is capable of, configured to, or operable to support a means for outputting a second DCI message prior to the first DCI message, the second DCI message indicating that the UE is to operate at the first subband, and the network entity expecting that a scheduling expectation is set at the UE in accordance with the second DCI message indicating that the UE is to operate at the first subband.

In some examples, the network entity determines that the UE missed a third DCI message, between the second DCI message and the first DCI message, indicating the UE to switch from the first subband to the second subband in accordance with obtaining the uplink message.

In some examples, the set of parameters is associated with the active BWP and both of the first subband and the second subband. In some examples, the set of parameters includes one or more of one or more first parameters associated with a control resource set; one or more second parameters associated with a sounding reference signal configuration; one or more third parameters associated with configured grant communications; and one or more fourth parameters associated with semi-persistently scheduled communications.

In some examples, the network entity outputs the first DCI message via a set of downlink control channel resources associated with the control resource set.

In some examples, the first valid quantity of PRBs defines a first set of one or more PRBs that are usable for scheduling within the first subband. In some examples, the second valid quantity of PRBs defines a second set of one or more PRBs that are usable for scheduling within the second subband.

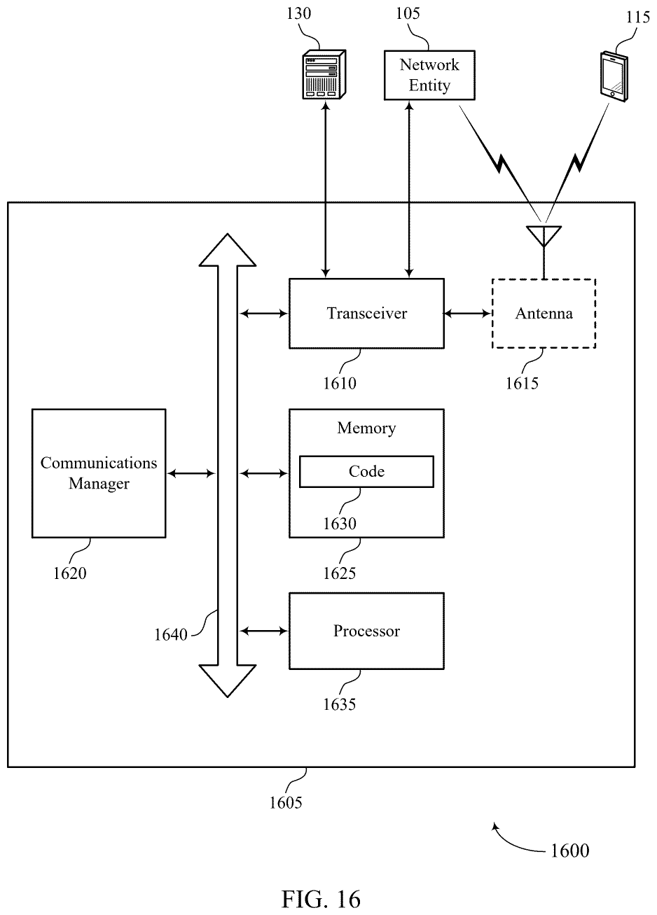

FIG. 16 shows a diagram of a system 1600 including a device 1605 that supports subband synchronization with light adaptation between subbands of an active BWP. The device 1605 may be an example of or include components of a device 1305, a device 1405, or a network entity 105 as described herein. The device 1605 may communicate with other network devices or network equipment such as one or more of the network entities 105, UEs 115, or any combination thereof. The communications may include communications over one or more wired interfaces, over one or more wireless interfaces, or any combination thereof. The device 1605 may include components that support outputting and obtaining communications, such as a communications manager 1620, a transceiver 1610, one or more antennas 1615, at least one memory 1625, code 1630, and at least one processor 1635. These components may be in electronic communication or otherwise coupled (such as operatively, communicatively, functionally, electronically, electrically) via one or more buses (such as a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (such as concurrently). The transceiver 1610 may also include a modem to modulate signals, to provide the modulated signals for transmission (such as by one or more antennas 1615, by a wired transmitter), to receive modulated signals (such as from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or one or more memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or one or more memory components (such as the at least one processor 1635, the at least one memory 1625, or both), may be included in a chip or chip assembly that is installed in the device 1605. In some examples, the transceiver 1610 may be operable to support communications via one or more communications links (such as communication link(s) 125, backhaul communication link(s) 120, a midhaul communication link 162, a fronthaul communication link 168).

The at least one memory 1625 may include RAM, ROM, or any combination thereof. The at least one memory 1625 may store computer-readable, computer-executable, or processor-executable code, such as the code 1630. The code 1630 may include instructions that, when executed by one or more of the at least one processor 1635, cause the device 1605 to perform various functions described herein. The code 1630 may be stored in a non-transitory computer-readable medium such as system memory or another type of memory. In some cases, the code 1630 may not be directly executable by a processor of the at least one processor 1635 but may cause a computer (such as when compiled and executed) to perform functions described herein. In some cases, the at least one memory 1625 may include, among other things, a BIOS which may control basic hardware or software operation such as the interaction with peripheral components or devices. In some examples, the at least one processor 1635 may include multiple processors and the at least one memory 1625 may include multiple memories. One or more of the multiple processors may be coupled with one or more of the multiple memories which may, individually or collectively, be configured to perform various functions herein (for example, as part of a processing system).

The at least one processor 1635 may include one or more intelligent hardware devices (such as one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1635 may be configured to operate a memory array using a memory controller. In some other cases, a memory controller may be integrated into one or more of the at least one processor 1635. The at least one processor 1635 may be configured to execute computer-readable instructions stored in a memory (such as one or more of the at least one memory 1625) to cause the device 1605 to perform various functions (such as functions or tasks supporting subband synchronization with light adaptation between subbands of an active BWP). For example, the device 1605 or a component of the device 1605 may include at least one processor 1635 and at least one memory 1625 coupled with one or more of the at least one processor 1635, the at least one processor 1635 and the at least one memory 1625 configured to perform various functions described herein. The at least one processor 1635 may be an example of a cloud-computing platform (such as one or more physical nodes and supporting software such as operating systems, virtual machines, or container instances) that may host the functions (such as by executing code 1630) to perform the functions of the device 1605. The at least one processor 1635 may be any one or more suitable processors capable of executing scripts or instructions of one or more software programs stored in the device 1605 (such as within one or more of the at least one memory 1625).

In some examples, the at least one processor 1635 may include multiple processors and the at least one memory 1625 may include multiple memories. One or more of the multiple processors may be coupled with one or more of the multiple memories, which may, individually or collectively, be configured to perform various functions herein. In some examples, the at least one processor 1635 may be a component of a processing system, which may refer to a system (such as a series) of machines, circuitry (including, for example, one or both of processor circuitry (which may include the at least one processor 1635) and memory circuitry (which may include the at least one memory 1625)), or components, that receives or obtains inputs and processes the inputs to produce, generate, or obtain a set of outputs. The processing system may be configured to perform one or more of the functions described herein. For example, the at least one processor 1635 or a processing system including the at least one processor 1635 may be configured to, configurable to, or operable to cause the device 1605 to perform one or more of the functions described herein. Further, as described herein, being “configured to,” being “configurable to,” and being “operable to” may be used interchangeably and may be associated with a capability, when executing code stored in the at least one memory 1625 or otherwise, to perform one or more of the functions described herein. In some implementations, one or more of the multiple memories may be configured to store processor-executable code that, when executed, may configure one or more of the multiple processors to perform various functions described herein (as part of a processing system). In some other implementations, the processing system may be pre-configured to perform various functions described herein.

The processing system of the device 1605 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, a bus 1640 may support communications of (such as within) a protocol layer of a protocol stack. In some examples, a bus 1640 may support communications associated with a logical channel of a protocol stack (such as between protocol layers of a protocol stack), which may include communications performed within a component of the device 1605, or between different components of the device 1605 that may be co-located or located in different locations (such as where the device 1605 may refer to a system in which one or more of the communications manager 1620, the transceiver 1610, the at least one memory 1625, the code 1630, and the at least one processor 1635 may be located in one of the different components or divided between different components).

In some examples, the communications manager 1620 may manage aspects of communications with a core network 130 (such as via one or more wired or wireless backhaul links). For example, the communications manager 1620 may manage the transfer of data communications for client devices, such as one or more UEs 115. In some examples, the communications manager 1620 may manage communications with one or more other network entities 105, and may include a controller or scheduler for controlling communications with UEs 115 (such as in cooperation with the one or more other network devices). In some examples, the communications manager 1620 may support an X2 interface within an LTE/LTE-A wireless communications network technology to provide communication between network entities 105.

The communications manager 1620 may support wireless communication in accordance with examples as disclosed herein. For example, the communications manager 1620 is capable of, configured to, or operable to support a means for outputting first configuration information indicative of a set of parameters associated with an active BWP of a UE and, as part of the first configuration information, second configuration information indictive of at least a first subband that includes a first valid quantity of PRBs and a second subband that includes a second valid quantity of PRBs. The communications manager 1620 is capable of, configured to, or operable to support a means for outputting a first DCI message that indicates an FDRA associated with a downlink data message, the FDRA including one or more PRBs that are invalid for the first subband and valid for the second subband. The communications manager 1620 is capable of, configured to, or operable to support a means for obtaining an uplink message in accordance with the FDRA including the one or more PRBs.

By including or configuring the communications manager 1620 in accordance with examples as described herein, the device 1605 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1620 may be configured to perform various operations (such as receiving, obtaining, monitoring, outputting, transmitting) using or otherwise in cooperation with the transceiver 1610, the one or more antennas 1615 (such as where applicable), or any combination thereof. Although the communications manager 1620 is illustrated as a separate component, in some examples, one or more functions described with reference to the communications manager 1620 may be supported by or performed by the transceiver 1610, one or more of the at least one processor 1635, one or more of the at least one memory 1625, the code 1630, or any combination thereof (for example, by a processing system including at least a portion of the at least one processor 1635, the at least one memory 1625, the code 1630, or any combination thereof). For example, the code 1630 may include instructions executable by one or more of the at least one processor 1635 to cause the device 1605 to perform various aspects of subband synchronization with light adaptation between subbands of an active BWP as described herein, or the at least one processor 1635 and the at least one memory 1625 may be otherwise configured to, individually or collectively, perform or support such operations.

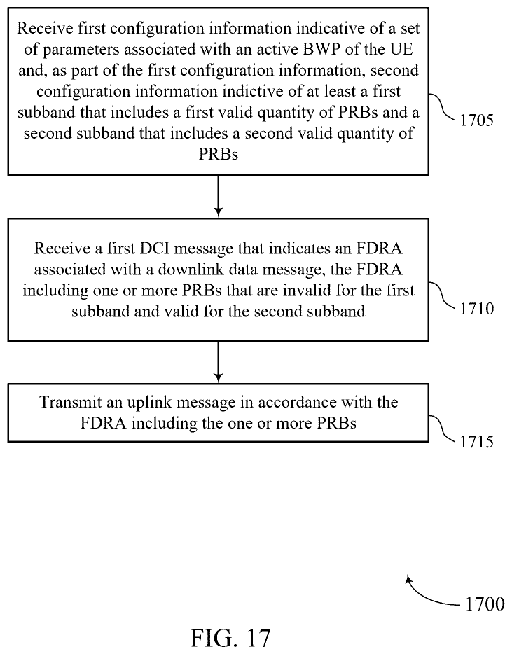

FIG. 17 shows a flowchart illustrating a method 1700 that supports subband synchronization with light adaptation between subbands of an active BWP. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include receiving first configuration information indicative of a set of parameters associated with an active BWP of the UE and, as part of the first configuration information, second configuration information indictive of at least a first subband that includes a first valid quantity of PRBs and a second subband that includes a second valid quantity of PRBs. The operations of 1705 may be performed in accordance with examples as disclosed herein. In some examples, aspects of the operations of 1705 may be performed by a BWP configuration component 1125 as described with reference to FIG. 11.

At 1710, the method may include receiving a first DCI message that indicates an FDRA associated with a downlink data message, the FDRA including one or more PRBs that are invalid for the first subband and valid for the second subband. The operations of 1710 may be performed in accordance with examples as disclosed herein. In some examples, aspects of the operations of 1710 may be performed by a DCI reception component 1130 as described with reference to FIG. 11.

At 1715, the method may include transmitting an uplink message in accordance with the FDRA including the one or more PRBs. The operations of 1715 may be performed in accordance with examples as disclosed herein. In some examples, aspects of the operations of 1715 may be performed by an FDRA feedback component 1135 as described with reference to FIG. 11.

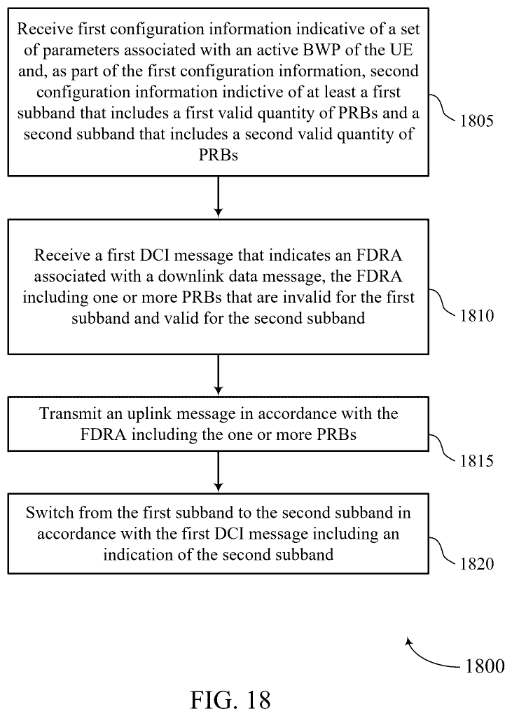

FIG. 18 shows a flowchart illustrating a method 1800 that supports subband synchronization with light adaptation between subbands of an active BWP. The operations of the method 1800 may be implemented by a UE or its components as described herein. For example, the operations of the method 1800 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1805, the method may include receiving first configuration information indicative of a set of parameters associated with an active BWP of the UE and, as part of the first configuration information, second configuration information indictive of at least a first subband that includes a first valid quantity of PRBs and a second subband that includes a second valid quantity of PRBs. The operations of 1805 may be performed in accordance with examples as disclosed herein. In some examples, aspects of the operations of 1805 may be performed by a BWP configuration component 1125 as described with reference to FIG. 11.

At 1810, the method may include receiving a first DCI message that indicates an FDRA associated with a downlink data message, the FDRA including one or more PRBs that are invalid for the first subband and valid for the second subband. The operations of 1810 may be performed in accordance with examples as disclosed herein. In some examples, aspects of the operations of 1810 may be performed by a DCI reception component 1130 as described with reference to FIG. 11.

At 1815, the method may include transmitting an uplink message in accordance with the FDRA including the one or more PRBs. The operations of 1815 may be performed in accordance with examples as disclosed herein. In some examples, aspects of the operations of 1815 may be performed by an FDRA feedback component 1135 as described with reference to FIG. 11.

At 1820, the method may include switching from the first subband to the second subband in accordance with the first DCI message including an indication of the second subband. The operations of 1820 may be performed in accordance with examples as disclosed herein. In some examples, aspects of the operations of 1820 may be performed by a subband switching component 1140 as described with reference to FIG. 11.

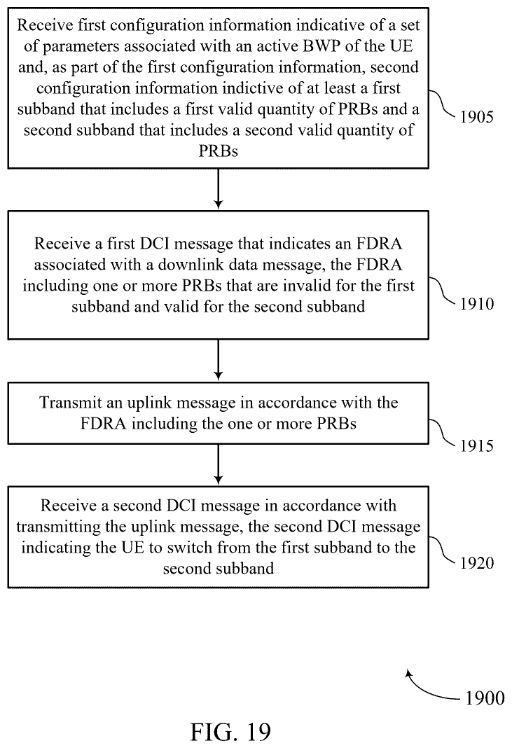

FIG. 19 shows a flowchart illustrating a method 1900 that supports subband synchronization with light adaptation between subbands of an active BWP. The operations of the method 1900 may be implemented by a UE or its components as described herein. For example, the operations of the method 1900 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1905, the method may include receiving first configuration information indicative of a set of parameters associated with an active BWP of the UE and, as part of the first configuration information, second configuration information indictive of at least a first subband that includes a first valid quantity of PRBs and a second subband that includes a second valid quantity of PRBs. The operations of 1905 may be performed in accordance with examples as disclosed herein. In some examples, aspects of the operations of 1905 may be performed by a BWP configuration component 1125 as described with reference to FIG. 11.

At 1910, the method may include receiving a first DCI message that indicates an FDRA associated with a downlink data message, the FDRA including one or more PRBs that are invalid for the first subband and valid for the second subband. The operations of 1910 may be performed in accordance with examples as disclosed herein. In some examples, aspects of the operations of 1910 may be performed by a DCI reception component 1130 as described with reference to FIG. 11.

At 1915, the method may include transmitting an uplink message in accordance with the FDRA including the one or more PRBs. The operations of 1915 may be performed in accordance with examples as disclosed herein. In some examples, aspects of the operations of 1915 may be performed by an FDRA feedback component 1135 as described with reference to FIG. 11.

At 1920, the method may include receiving a second DCI message in accordance with transmitting the uplink message, the second DCI message indicating the UE to switch from the first subband to the second subband. The operations of 1920 may be performed in accordance with examples as disclosed herein. In some examples, aspects of the operations of 1920 may be performed by a DCI reception component 1130 as described with reference to FIG. 11.

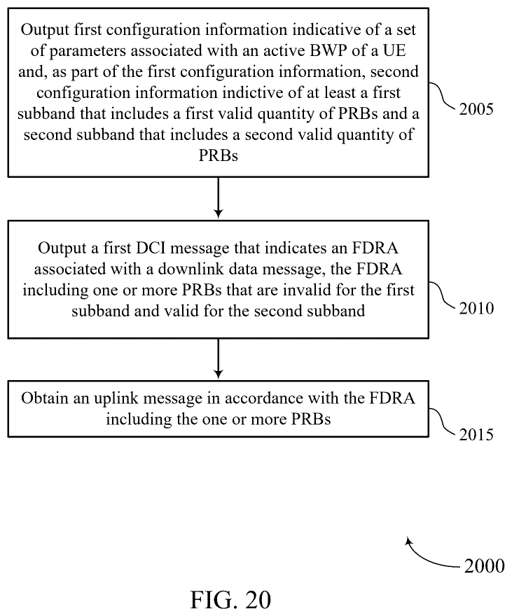

FIG. 20 shows a flowchart illustrating a method 2000 that supports subband synchronization with light adaptation between subbands of an active BWP. The operations of the method 2000 may be implemented by a network entity or its components as described herein. For example, the operations of the method 2000 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2005, the method may include outputting first configuration information indicative of a set of parameters associated with an active BWP of a UE and, as part of the first configuration information, second configuration information indictive of at least a first subband that includes a first valid quantity of PRBs and a second subband that includes a second valid quantity of PRBs. The operations of 2005 may be performed in accordance with examples as disclosed herein. In some examples, aspects of the operations of 2005 may be performed by a BWP configuration component 1525 as described with reference to FIG. 15.

At 2010, the method may include outputting a first DCI message that indicates an FDRA associated with a downlink data message, the FDRA including one or more PRBs that are invalid for the first subband and valid for the second subband. The operations of 2010 may be performed in accordance with examples as disclosed herein. In some examples, aspects of the operations of 2010 may be performed by a DCI transmission component 1530 as described with reference to FIG. 15.

At 2015, the method may include obtaining an uplink message in accordance with the FDRA including the one or more PRBs. The operations of 2015 may be performed in accordance with examples as disclosed herein. In some examples, aspects of the operations of 2015 may be performed by an FDRA feedback component 1535 as described with reference to FIG. 15.

The following provides an overview of aspects of the present disclosure:
Aspect 1: A method for wireless communication at a UE, including: receiving first configuration information indicative of a set of parameters associated with an active BWP of the UE and, as part of the first configuration information, second configuration information indictive of at least a first subband that includes a first valid quantity of PRBs and a second subband that includes a second valid quantity of PRBs; receiving a first DCI message that indicates an FDRA associated with a downlink data message, the FDRA including one or more PRBs that are invalid for the first subband and valid for the second subband; and transmitting an uplink message in accordance with the FDRA including the one or more PRBs.
Aspect 2: The method of aspect 1, where the UE operates at the first subband at a reception time of the first DCI message, and the FDRA is not limited to a set of usable PRBs that the UE considers to be valid for data reception within the first subband in accordance with the FDRA including the one or more PRBs that are invalid for the first subband and valid for the second subband.
Aspect 3: The method of aspect 2, where the uplink message includes a negative acknowledgment, and the UE switches to the second subband in accordance with the FDRA including the one or more PRBs that are valid for the second subband.
Aspect 4: The method of any of aspects 2-3, where the uplink message includes an indication that the FDRA is not limited to the set of usable PRBs that the UE considers to be valid for the data reception within the first subband, and the UE switches to the second subband in accordance with the FDRA including the one or more PRBs that are valid for the second subband.
Aspect 5: The method of aspect 4, where the uplink message includes a UCI message or a MAC-CE, and a field associated with indicating mismatched subband scenarios within the UCI message or the MAC-CE includes the indication that the FDRA is not limited to the set of usable PRBs that the UE considers to be valid for the data reception within the first subband.
Aspect 6: The method of any of aspects 4-5, where the uplink message includes a feedback message, and a multi-bit field within the feedback message includes the indication that the FDRA is not limited to the set of usable PRBs that the UE considers to be valid for the data reception within the first subband.
Aspect 7: The method of aspect 6, where a first value of the multi-bit field within the feedback message corresponds to the indication of the FDRA being not limited to the set of usable PRBs that the UE considers to be valid for the data reception within the first subband; a second value of the multi-bit field within the feedback message corresponds to a positive acknowledgment associated with the downlink data message; and a third value of the multi-bit field within the feedback message corresponds to a negative acknowledgment associated with the downlink data message.
Aspect 8: The method of any of aspects 1-7, where the one or more PRBs of the FDRA are valid for the second subband in accordance with the first DCI message including an indication of the second subband or the FDRA failing to satisfy a scheduling restriction associated with the first subband.
Aspect 9: The method of any of aspects 1-8, further including: switching from the first subband to the second subband in accordance with the first DCI message including an indication of the second subband.
Aspect 10: The method of any of aspects 1-9, further including: receiving a second DCI message in accordance with transmitting the uplink message, the second DCI message indicating the UE to switch from the first subband to the second subband.
Aspect 11: The method of any of aspects 1-10, further including: receiving a second DCI message prior to the first DCI message, the second DCI message indicating that the UE is to operate at the first subband, and a scheduling expectation being set at the UE in accordance with the second DCI message indicating that the UE is to operate at the first subband.
Aspect 12: The method of aspect 11, where the UE determines that the UE missed a third DCI message, between the second DCI message and the first DCI message, indicating the UE to switch from the first subband to the second subband in accordance with the FDRA including the one or more PRBs that are invalid for the first subband and valid for the second subband.
Aspect 13: The method of any of aspects 1-12, where the set of parameters is associated with the active BWP and both of the first subband and the second subband, and the set of parameters includes one or more of one or more first parameters associated with a CORESET; one or more second parameters associated with an SRS configuration; one or more third parameters associated with configured grant communications; and one or more fourth parameters associated with semi-persistently scheduled communications.
Aspect 14: The method of aspect 13, where the UE receives the first DCI message via a set of downlink control channel resources associated with the CORESET.
Aspect 15: The method of any of aspects 1-14, where the first valid quantity of PRBs defines a first set of one or more PRBs that are usable for scheduling within the first subband; and the second valid quantity of PRBs defines a second set of one or more PRBs that are usable for scheduling within the second subband.
Aspect 16: A method for wireless communication at a network entity, including: outputting first configuration information indicative of a set of parameters associated with an active BWP of a UE and, as part of the first configuration information, second configuration information indictive of at least a first subband that includes a first valid quantity of PRBs and a second subband that includes a second valid quantity of PRBs; outputting a first DCI message that indicates an FDRA associated with a downlink data message, the FDRA including one or more PRBs that are invalid for the first subband and valid for the second subband; and obtaining an uplink message in accordance with the FDRA including the one or more PRBs.
Aspect 17: The method of aspect 16, where the uplink message includes a negative acknowledgment in accordance with the FDRA including the one or more PRBs that are invalid for the first subband and valid for the second subband, and the network entity expects the UE to switch to the second subband in accordance with the FDRA including the one or more PRBs that are valid for the second subband.
Aspect 18: The method of any of aspects 16-17, where the uplink message includes an indication that the FDRA is not limited to a set of usable PRBs that the UE considers to be valid for data reception within the first subband, and the network entity expects the UE to switch to the second subband in accordance with the FDRA including the one or more PRBs that are valid for the second subband.
Aspect 19: The method of aspect 18, where the uplink message includes a UCI message or a MAC-CE, and a field associated with indicating mismatched subband scenarios within the UCI message or the MAC-CE includes the indication that the FDRA is not limited to the set of usable PRBs that the UE considers to be valid for the data reception within the first subband.
Aspect 20: The method of any of aspects 18-19, where the uplink message includes a feedback message, and a multi-bit field within the feedback message includes the indication that the FDRA is not limited to the set of usable PRBs that the UE considers to be valid for the data reception within the first subband.
Aspect 21: The method of aspect 20, where a first value of the multi-bit field within the feedback message corresponds to the indication of the FDRA being not limited to the set of usable PRBs that the UE considers to be valid for the data reception within the first subband; a second value of the multi-bit field within the feedback message corresponds to a positive acknowledgment associated with the downlink data message; and a third value of the multi-bit field within the feedback message corresponds to a negative acknowledgment associated with the downlink data message.
Aspect 22: The method of any of aspects 16-21, where the one or more PRBs of the FDRA are valid for the second subband in accordance with the first DCI message including an indication of the second subband or the FDRA failing to satisfy a scheduling restriction associated with the first subband.
Aspect 23: The method of any of aspects 16-22, further including: outputting a second DCI message in accordance with obtaining the uplink message, the second DCI message indicating the UE to switch from the first subband to the second subband.
Aspect 24: The method of any of aspects 16-23, further including: outputting a second DCI message prior to the first DCI message, the second DCI message indicating that the UE is to operate at the first subband, and the network entity expecting that a scheduling expectation is set at the UE in accordance with the second DCI message indicating that the UE is to operate at the first subband.
Aspect 25: The method of aspect 24, where the network entity determines that the UE missed a third DCI message, between the second DCI message and the first DCI message, indicating the UE to switch from the first subband to the second subband in accordance with obtaining the uplink message.
Aspect 26: The method of any of aspects 16-25, where the set of parameters is associated with the active BWP and both of the first subband and the second subband, and the set of parameters includes one or more of one or more first parameters associated with a CORESET; one or more second parameters associated with an SRS configuration; one or more third parameters associated with configured grant communications; and one or more fourth parameters associated with semi-persistently scheduled communications.
Aspect 27: The method of aspect 26, where the network entity outputs the first DCI message via a set of downlink control channel resources associated with the CORESET.
Aspect 28: The method of any of aspects 16-27, where the first valid quantity of PRBs defines a first set of one or more PRBs that are usable for scheduling within the first subband; and the second valid quantity of PRBs defines a second set of one or more PRBs that are usable for scheduling within the second subband.
Aspect 29: An apparatus for wireless communication at a UE, including a processing system that includes processor circuitry and memory circuitry that stores code, the processing system configured to cause the apparatus to perform a method of any of aspects 1-15.
Aspect 30: An apparatus for wireless communication at a UE, including at least one means for performing a method of any of aspects 1-15.
Aspect 31: A non-transitory computer-readable medium storing code for wireless communication, the code including instructions executable by a processing system to perform a method of any of aspects 1-15.
Aspect 32: An apparatus for wireless communication at a network entity, including a processing system that includes processor circuitry and memory circuitry that stores code, the processing system configured to cause the apparatus to perform a method of any of aspects 16-28.
Aspect 33: An apparatus for wireless communication at a network entity, including at least one means for performing a method of any of aspects 16-28.
Aspect 34: A non-transitory computer-readable medium storing code for wireless communication, the code including instructions executable by a processing system to perform a method of any of aspects 16-28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (such as a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (such as a list of items prefaced by a phrase such as “at least one of” or “one or more of”) indicates an inclusive list such that, for example, a list of at least one of A, B, or C means A or B or C or AB or AC or BC or ABC (A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrases “based at least in part on,” “associated with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processing system that includes processor circuitry and memory circuitry that stores code, the processing system configured to cause the apparatus to:
receive first configuration information indicative of a set of parameters associated with an active bandwidth part of the UE and, as part of the first configuration information, second configuration information indictive of at least a first subband that comprises a first valid quantity of physical resource blocks and a second subband that comprises a second valid quantity of physical resource blocks;
receive a first downlink control information message that indicates a frequency domain resource allocation associated with a downlink data message, the frequency domain resource allocation comprising one or more physical resource blocks that are invalid for the first subband and valid for the second subband; and
transmit an uplink message in accordance with the frequency domain resource allocation comprising the one or more physical resource blocks.

2. The apparatus of claim 1, wherein the UE operates at the first subband at a reception time of the first downlink control information message, and wherein the frequency domain resource allocation is not limited to a set of usable physical resource blocks that the UE considers to be valid for data reception within the first subband in accordance with the frequency domain resource allocation comprising the one or more physical resource blocks that are invalid for the first subband and valid for the second subband.

3. The apparatus of claim 2, wherein the uplink message comprises a negative acknowledgment, and wherein the UE switches to the second subband in accordance with the frequency domain resource allocation comprising the one or more physical resource blocks that are valid for the second subband.

4. The apparatus of claim 2, wherein the uplink message comprises an indication that the frequency domain resource allocation is not limited to the set of usable physical resource blocks that the UE considers to be valid for the data reception within the first subband, and wherein the UE switches to the second subband in accordance with the frequency domain resource allocation comprising the one or more physical resource blocks that are valid for the second subband.

5. The apparatus of claim 4, wherein the uplink message comprises an uplink control information message or a medium access control (MAC) control element (MAC-CE), and wherein a field associated with indicating mismatched subband scenarios within the uplink control information message or the MAC-CE comprises the indication that the frequency domain resource allocation is not limited to the set of usable physical resource blocks that the UE considers to be valid for the data reception within the first subband.

6. The apparatus of claim 4, wherein the uplink message comprises a feedback message, and wherein a multi-bit field within the feedback message comprises the indication that the frequency domain resource allocation is not limited to the set of usable physical resource blocks that the UE considers to be valid for the data reception within the first subband.

7. The apparatus of claim 6, wherein:
a first value of the multi-bit field within the feedback message corresponds to the indication of the frequency domain resource allocation being not limited to the set of usable physical resource blocks that the UE considers to be valid for the data reception within the first subband;
a second value of the multi-bit field within the feedback message corresponds to a positive acknowledgment associated with the downlink data message; and
a third value of the multi-bit field within the feedback message corresponds to a negative acknowledgment associated with the downlink data message.

8. The apparatus of claim 1, wherein the one or more physical resource blocks of the frequency domain resource allocation are valid for the second subband in accordance with:
the first downlink control information message comprising an indication of the second subband; or
the frequency domain resource allocation failing to satisfy a scheduling restriction associated with the first subband.

9. The apparatus of claim 1, wherein the processing system is further configured to cause the apparatus to:
switch from the first subband to the second subband in accordance with the first downlink control information message comprising an indication of the second subband.

10. The apparatus of claim 1, wherein the processing system is further configured to cause the apparatus to:
receive a second downlink control information message in accordance with transmitting the uplink message, the second downlink control information message indicating the UE to switch from the first subband to the second subband.

11. The apparatus of claim 1, wherein the processing system is further configured to cause the apparatus to:
receive a second downlink control information message prior to the first downlink control information message, the second downlink control information message indicating that the UE is to operate at the first subband, and a scheduling expectation being set at the UE in accordance with the second downlink control information message indicating that the UE is to operate at the first subband.

12. The apparatus of claim 11, wherein the apparatus determines that the UE missed a third downlink control information message, between the second downlink control information message and the first downlink control information message, indicating the UE to switch from the first subband to the second subband in accordance with the frequency domain resource allocation comprising the one or more physical resource blocks that are invalid for the first subband and valid for the second subband.

13. The apparatus of claim 1, wherein the set of parameters is associated with the active bandwidth part and both of the first subband and the second subband, and wherein the set of parameters comprises one or more of:
one or more first parameters associated with a control resource set;
one or more second parameters associated with a sounding reference signal configuration;
one or more third parameters associated with configured grant communications; and
one or more fourth parameters associated with semi-persistently scheduled communications.

14. The apparatus of claim 1, wherein:
the first valid quantity of physical resource blocks defines a first set of one or more physical resource blocks that are usable for scheduling within the first subband; and
the second valid quantity of physical resource blocks defines a second set of one or more physical resource blocks that are usable for scheduling within the second subband.

15. An apparatus for wireless communication at a network entity, comprising:
a processing system that includes processor circuitry and memory circuitry that stores code, the processing system configured to cause the apparatus to:
output first configuration information indicative of a set of parameters associated with an active bandwidth part of a user equipment (UE) and, as part of the first configuration information, second configuration information indictive of at least a first subband that comprises a first valid quantity of physical resource blocks and a second subband that comprises a second valid quantity of physical resource blocks;
output a first downlink control information message that indicates a frequency domain resource allocation associated with a downlink data message, the frequency domain resource allocation comprising one or more physical resource blocks that are invalid for the first subband and valid for the second subband; and
obtain an uplink message in accordance with the frequency domain resource allocation comprising the one or more physical resource blocks.

16. The apparatus of claim 15, wherein the uplink message comprises a negative acknowledgment in accordance with the frequency domain resource allocation comprising the one or more physical resource blocks that are invalid for the first subband and valid for the second subband, and wherein the network entity expects the UE to switch to the second subband in accordance with the frequency domain resource allocation comprising the one or more physical resource blocks that are valid for the second subband.

17. The apparatus of claim 15, wherein the uplink message comprises an indication that the frequency domain resource allocation is not limited to a set of usable physical resource blocks that the UE considers to be valid for data reception within the first subband, and wherein the network entity expects the UE to switch to the second subband in accordance with the frequency domain resource allocation comprising the one or more physical resource blocks that are valid for the second subband.

18. The apparatus of claim 17, wherein the uplink message comprises an uplink control information message or a medium access control (MAC) control element (MAC-CE), and wherein a field associated with indicating mismatched subband scenarios within the uplink control information message or the MAC-CE comprises the indication that the frequency domain resource allocation is not limited to the set of usable physical resource blocks that the UE considers to be valid for the data reception within the first subband.

19. The apparatus of claim 17, wherein the uplink message comprises a feedback message, and wherein a multi-bit field within the feedback message comprises the indication that the frequency domain resource allocation is not limited to the set of usable physical resource blocks that the UE considers to be valid for the data reception within the first subband.

20. The apparatus of claim 19, wherein:
a first value of the multi-bit field within the feedback message corresponds to the indication of the frequency domain resource allocation being not limited to the set of usable physical resource blocks that the UE considers to be valid for the data reception within the first subband;
a second value of the multi-bit field within the feedback message corresponds to a positive acknowledgment associated with the downlink data message; and
a third value of the multi-bit field within the feedback message corresponds to a negative acknowledgment associated with the downlink data message.

21. The apparatus of claim 15, wherein the one or more physical resource blocks of the frequency domain resource allocation are valid for the second subband in accordance with:
the first downlink control information message comprising an indication of the second subband; or
the frequency domain resource allocation failing to satisfy a scheduling restriction associated with the first subband.

22. A method for wireless communication at a user equipment (UE), comprising:
receiving first configuration information indicative of a set of parameters associated with an active bandwidth part of the UE and, as part of the first configuration information, second configuration information indictive of at least a first subband that comprises a first valid quantity of physical resource blocks and a second subband that comprises a second valid quantity of physical resource blocks;
receiving a first downlink control information message that indicates a frequency domain resource allocation associated with a downlink data message, the frequency domain resource allocation comprising one or more physical resource blocks that are invalid for the first subband and valid for the second subband; and
transmitting an uplink message in accordance with the frequency domain resource allocation comprising the one or more physical resource blocks.

23. The method of claim 22, wherein the UE operates at the first subband at a reception time of the first downlink control information message, and wherein the frequency domain resource allocation is not limited to a set of usable physical resource blocks that the UE considers to be valid for data reception within the first subband in accordance with the frequency domain resource allocation comprising the one or more physical resource blocks that are invalid for the first subband and valid for the second subband.

24. The method of claim 23, wherein the uplink message comprises a negative acknowledgment, and wherein the UE switches to the second subband in accordance with the frequency domain resource allocation comprising the one or more physical resource blocks that are valid for the second subband.

25. The method of claim 23, wherein the uplink message comprises an indication that the frequency domain resource allocation is not limited to the set of usable physical resource blocks that the UE considers to be valid for the data reception within the first subband, and wherein the UE switches to the second subband in accordance with the frequency domain resource allocation comprising the one or more physical resource blocks that are valid for the second subband.

26. The method of claim 25, wherein the uplink message comprises an uplink control information message or a medium access control (MAC) control element (MAC-CE), and wherein a field associated with indicating mismatched subband scenarios within the uplink control information message or the MAC-CE comprises the indication that the frequency domain resource allocation is not limited to the set of usable physical resource blocks that the UE considers to be valid for the data reception within the first subband.

27. The method of claim 25, wherein the uplink message comprises a feedback message, and wherein a multi-bit field within the feedback message comprises the indication that the frequency domain resource allocation is not limited to the set of usable physical resource blocks that the UE considers to be valid for the data reception within the first subband.

28. A method for wireless communication at a network entity, comprising:
outputting first configuration information indicative of a set of parameters associated with an active bandwidth part of a user equipment (UE) and, as part of the first configuration information, second configuration information indictive of at least a first subband that comprises a first valid quantity of physical resource blocks and a second subband that comprises a second valid quantity of physical resource blocks;
outputting a first downlink control information message that indicates a frequency domain resource allocation associated with a downlink data message, the frequency domain resource allocation comprising one or more physical resource blocks that are invalid for the first subband and valid for the second subband; and
obtaining an uplink message in accordance with the frequency domain resource allocation comprising the one or more physical resource blocks.

29. The method of claim 28, wherein the uplink message comprises a negative acknowledgment in accordance with the frequency domain resource allocation comprising the one or more physical resource blocks that are invalid for the first subband and valid for the second subband, and wherein the network entity expects the UE to switch to the second subband in accordance with the frequency domain resource allocation comprising the one or more physical resource blocks that are valid for the second subband.

30. The method of claim 28, wherein the uplink message comprises an indication that the frequency domain resource allocation is not limited to a set of usable physical resource blocks that the UE considers to be valid for data reception within the first subband, and wherein the network entity expects the UE to switch to the second subband in accordance with the frequency domain resource allocation comprising the one or more physical resource blocks that are valid for the second subband.
